(19) United States
(12) Patent Application Publication
(10) Pub. No.: US 2020/0300664 A1
(43) Pub. Date: Sep. 24, 2020

(54) METHOD AND SYSTEM FOR MONITORING WATER FLOW

(71) Applicant: MoniThing LLC, Fremont, CA (US)

(72) Inventor: Wei Zhou, Fremont, CA (US)

(73) Assignee: MoniThing LLC, Fremont, CA (US)

(21) Appl. No.: 16/356,175

(22) Filed: Mar. 18, 2019

(51) Int. Cl. G01D 4/00; H04L 29/08; G01F 15/06

(52) U.S. Cl. CPC G01D 4/006; G01F 15/063; H04L 67/12; H04L 67/025

(57) ABSTRACT

A method and system monitors waterflow through a plumbing fixture and generates waterflow monitoring data with a waterflow monitoring device. The method and system analyzes the waterflow monitoring data with a cloud-based waterflow analysis system. The waterflow analysis system outputs waterflow monitoring data to a computing device of a user of the waterflow analysis system.

### BACKGROUND

Humans use water for a large variety of reasons. Each individual person requires water for drinking each day. Farmers require large amounts of water to grow and harvest crops that represent the primary food supplies of the world. People use water each day for cooking, cleaning, showering, and disposing of human waste. Furthermore, individuals also typically use water for watering lawns, gardens, and decorative vegetation.

As the human population of the Earth increases, conservation of water becomes increasingly important. Supplies of fresh water are not limitless. In some areas, fresh water reservoirs have been entirely depleted due to overuse, requiring emergency measures by local governments and populations in order to meet the most basic water needs of individuals.

In addition to rising human populations, climate change also plays an increasingly large role in water conservation. Due to the changing climate, some areas may suffer reduced yearly precipitation. Others may face increasing temperatures, causing a corresponding increase in the loss of water in reservoirs and rivers from evaporation.

Accordingly, there is a clear need for more effective water conservation methods in order to preserve water supplies. Water conservation is important in both large-scale agricultural operations, and in the daily routines of individuals in their homes.

Some water conservation systems have sought to reduce water use by implementing more efficient water usage devices. For example, many jurisdictions now require that toilets use reduced amounts of water per flush. Some jurisdictions have restricted the total amount of water that a user can user. Toilet manufacturers have developed toilets that enable separate flushing functions for entirely liquid and solid waste, so that less water can be used to flush liquids. Other conservation systems track overall water usage in a home. In this way, people can see their overall water usage and possibly attempt to decrease it.

However, in spite of these advancements, traditional water conservation systems are not able to provide more nuanced water conservation assistance to people. For instance, there are many sources of water use in a typical home. These typically showers, bath tubs, kitchen faucets, bathroom faucets, washing machines, dish washers, outdoor spickets, swimming pools, and toilets. Each of these vary by manufacturer, by the usage habits of users, and based on local water pressure. Traditional water conservation efforts have not been able to provide effective water conservation assistance based on the particular circumstances of individual water sources within a home, and the habits and patterns of the people that use them.

What is needed is a method and system that solves the long-standing technical problem of water conservation systems that do not provide individualized water conservation assistance based on the unique circumstances of each home and the people within it.

### SUMMARY

Embodiments of the present disclosure provide one or more technical solutions to the technical problem of water conservation systems that do not provide individualized water conservation assistance based on the unique circumstances of each home and the people within it. Embodiments of the present disclosure utilize a water flow monitoring device positioned in a plumbing system. The water flow monitoring device tracks the flow of water in a portion of the plumbing system and outputs waterflow monitoring data to a cloud-based waterflow analysis system. The waterflow analysis system analyzes the waterflow monitoring data in accordance with one or more machine learning models. The waterflow analysis system outputs waterflow notification data to a computing device of the user. The computing device of the user displays the waterflow notification data to the user. The user is able to take water conservation actions based on the waterflow notification data.

Embodiments of the present disclosure address some of the shortcomings associated with traditional water conservation systems. Machine learning analysis is performed on waterflow metrics to determine water conservation data that can be provided to users based on the characteristics of the plumbing situations of the users. The various embodiments of the disclosure can be implemented to improve the technical fields of water conservation, data management, data processing, and data transmission. Therefore, the various described embodiments of the disclosure and their associated benefits amount to significantly more than an abstract idea.

### BRIEF DESCRIPTION OF THE DRAWINGS

FIG. 1 is a block diagram of a system for assisting users to conserve water, in accordance with one embodiment.

FIG. 2A is a block diagram of a waterflow monitoring device, in accordance with one embodiment.

FIG. 2B is an illustration of a waterflow monitoring device, in accordance with one embodiment.

FIG. 2C is an illustration of components of a waterflow monitoring device, in accordance with one embodiment.

FIG. 2D is an illustration of components of a waterflow monitoring device, in accordance with one embodiment.

FIG. 3 is a block diagram of a production environment for assisting users to conserve water, according to one embodiment.

FIG. 4 is a graph illustrating current draw from a waterflow monitoring device and current produced by a micro hydropower generator, in accordance with one embodiment.

FIG. 5 illustrates a functional flow diagram of a process for assisting users to conserve water, in accordance with one embodiment.

FIG. 6 illustrates a functional flow diagram of a process corresponding to a hardware logic flowchart for a waterflow monitoring device, in accordance with one embodiment.

FIG. 7 illustrates a functional flow diagram of a process corresponding to a firmware logic flowchart for a waterflow monitoring device, in accordance with one embodiment.

FIG. 8 illustrates a functional flow diagram of a process corresponding to a service flowchart for a waterflow analysis system, in accordance with one embodiment, in accordance with one embodiment.

FIG. 9 illustrates a functional flow diagram of a process for utilizing a waterflow monitoring device, a waterflow analysis system, and a user computing device 106 to assist the user in conserving water, in accordance with one embodiment.

FIG. 10 is a flow diagram of a process for assisting users to conserve water, in accordance with one embodiment.

Common reference numerals are used throughout the FIGs and the detailed description to indicate like elements. One skilled in the art will readily recognize that the above FIGs are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs, which depict one or more exemplary embodiments. Embodiments may be implemented in many different forms and should not be construed as limited to the embodiments set forth herein, shown in the FIGs, and/or described below. Rather, these exemplary embodiments are provided to allow a complete disclosure that conveys the principles of the invention, as set forth in the claims, to those of skill in the art.

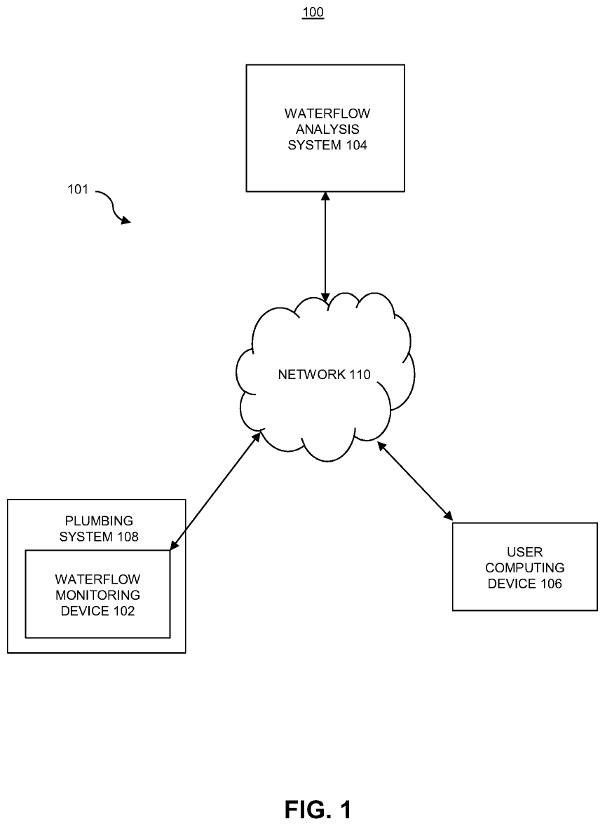

FIG. 1 illustrates a block diagram of a production environment 100 for assisting users to conserve water, according to one embodiment. The production environment 100 includes a water conservation system 101. The water conservation system 101 includes a waterflow monitoring device 102 positioned in a plumbing system 108, a waterflow analysis system 104. And a user computing device 106, according to various embodiments. The waterflow monitoring device 102, the waterflow analysis system 104, and the user computing device 106 are communicatively connected by one or more networks 110.

In one embodiment, the waterflow monitoring device 102 is disposed within the plumbing system 108. The waterflow monitoring device 102 can be disposed in the plumbing system 108 in order to monitor the flow of water through one or more plumbing fixtures. Plumbing fixtures can include toilets, kitchen faucets, bathroom faucets, showers, bathtubs, washing machines, dishwashing machines, swimming pool, sprinkling systems, or other types of plumbing fixtures that are known at the time of filing of this application, or that may become known after the time of filing of this application.

In one embodiment, the waterflow monitoring device 102 measures the waterflow through the one or more plumbing fixtures. The waterflow monitoring device 102 transmits waterflow monitoring data from the waterflow monitoring device 102 to the waterflow analysis system 104. The waterflow monitoring data indicates characteristics of the flow of water through the one or more plumbing fixtures monitored by the waterflow monitoring device 102. The waterflow monitoring data can include a time periods or lengths of time during which water flowed through the one or more plumbing fixtures. The waterflow monitoring data can include flow rates of the water through the one or more plumbing fixtures during the times that water flowed through the one or more plumbing fixtures. The flow rate data can include dates and times of waterflow. The waterflow monitoring data can include ranges of time during which water flowed. The waterflow monitoring data can include total waterflow for a given period of time. The waterflow monitoring data can include other kinds of data indicative of water use in waterflow through the one or more plumbing fixtures, as will be apparent to those of skill in the art in light of the present disclosure.

In one embodiment, the waterflow monitoring device 102 can also measure the flow of water by detecting the water pressure. The total flow of water during a period of time can be calculated based on the water pressure and the duration of waterflow. Higher water pressure results in a higher flow rate of water in terms of volume per second. Accordingly, in one embodiment, the total flow of water can be calculated by the waterflow monitoring device 102 based on the water pressure and the length of time of waterflow.

In one embodiment, the waterflow monitoring device 102 is connected to a local network. The local network can include a local area network (LAN), wireless area network (WAN), or other types of networks that are used to connect devices to each other and/or to the Internet in a home, a business, an educational institution, a government institution, or other types of institutions or facilities in which plumbing fixtures are commonly used.

In one embodiment, the waterflow monitoring device 102 connects to the networks 110 by connecting to a wireless router. The wireless router can host a wireless network. The waterflow monitoring device 102 can connect to a network via a Wi-Fi protocol a Bluetooth protocol, a ZigBee protocol, or other types of wireless communication protocols.

In one embodiment, the waterflow monitoring device can be connected to the one or more networks 110 via a wired connection. The wired connection can include an ethernet connection, a USB connection, or other types of wired connections such as are known at the time of filing or become known after the time of filing.

In one embodiment, the waterflow analysis system 104 receives the waterflow monitoring data from the waterflow monitoring device 102 via the one or more networks 110. The waterflow analysis system 104 analyzes the waterflow monitoring data and identifies characteristics of the waterflow through the one or more plumbing fixtures. The waterflow analysis system 104 generates waterflow notification data based on the characteristics of the waterflow.

In one embodiment, the waterflow analysis system 104 is a cloud-based analysis system. The waterflow analysis system 104 can include analysis models implemented in one or more servers, one or more computing devices, one or more virtual machines, one or more machine images, or other computing systems capable of performing analysis on the waterflow monitoring data at a location remote from the waterflow monitoring device 102.

In one embodiment, the one or more networks 110 include the Internet. The waterflow monitoring device 102 passes the waterflow monitoring data to the cloud-based water analysis system 104 via the Internet and any intervening networks.

In one embodiment, after the waterflow analysis system 104 has generated waterflow notification data, the waterflow analysis system 104 outputs the waterflow notification data to the user computing device 106. The waterflow analysis system 104 is connected to the user computing device 106 by the one or more networks 110. The one or more networks 110, as described previously, can include one or more of the Internet, LANs, WANs, or other communication networks.

In one embodiment, the user computing device 106 includes a computing device of the user. The user can include an individual or organization that has installed the waterflow monitoring device 102 or that monitors the plumbing system 108. The user computing device 106 can include a personal computing device of the user such as a mobile phone, a tablet, a laptop computer, a desktop computer, a voice recognition device, a wearable smart device, such as a smart watch, or other types of personal computing devices that are accessible by the user.

In one embodiment, the user computing device 106 receives the waterflow notification data from the waterflow analysis system 102 and displays the waterflow notification data to the user. When the user accesses the user computing device 106, the user can view the waterflow notification data. The user can then take water conservation measures, if needed, based on the waterflow notification data.

In one embodiment, the user first receives waterflow notification data on a user computing device 106 that is not able to display the full text or images associated with the waterflow notification data. For example, the user may receive a waterflow notification in the form of an audio alert from a voice recognition listening device. The user may then check a second user computing device, such as a smart phone, for example, in order to receive the full text or images of the waterflow notification data. Accordingly, the user may receive a first portion of waterflow notification data, such as an alert, on a first user computing device 106 and may then check a second user computing device 106 in order to fully view the waterflow notification data.

In one embodiment, the waterflow notification data includes analysis generated by the waterflow analysis system 104 based on the waterflow monitoring data received from the waterflow monitoring device 102. The waterflow notification data can include data indicating how much water is used by the one or more plumbing fixtures monitored by the waterflow monitoring device 102, how often water flows through the one or more plumbing fixtures, times of day that water flows through the one or more plumbing fixtures, aggregated data reflecting waterflow over a particular time period, comparison data indicating how much water was used in one aggregation period versus another aggregation period, changes in waterflow patterns, or other types of waterflow analysis.

In one embodiment, the waterflow notification data can include an amount of waterflow through the plumbing fixture in particular instances. In an example in which the plumbing fixture is a toilet, the waterflow notification data can indicate how much water was used on each individual flush. The waterflow notification data can also indicate the average amount of water used per flush. The waterflow notification data can also indicate the number of flushes per day. The waterflow notification data can indicate the times of day of individual toilet flushes. The waterflow notification data can also include waterflow quantification and time data for plumbing fixtures other than toilets. All of this data can inform the user and assist the user in the user's water conservation efforts.

In one embodiment, the waterflow notification data includes one or more recommended actions to be taken by the user. For example, the waterflow notification data can indicate that there is likely a leak associated with the one or more plumbing fixtures based on the waterflow monitoring data. The waterflow notification data can encourage the user to check for a leak or replace a plumbing fixture. The waterflow notification data can recommend to the user ways that the user could better conserve water based on the analysis of the waterflow monitoring data.

In one embodiment, the waterflow analysis system 104 generates waterfowl notification data based on water usage of a community of users of the waterflow analysis system 104. The waterflow analysis system can generate notification data that informs a user how the user's water usage compares to other users of the waterflow analysis system 104. For example, the waterflow notification data can indicate to the user that a plumbing fixture of the user utilizes more water on average than plumbing fixtures of that type of other users. The waterflow notification data can include recommendations to improve conservation of water in the plumbing fixture. If the waterflow notification data indicates that the plumbing fixture uses less water than typical plumbing fixtures of that type, then the waterflow notification data can include positive feedback for the user to encourage the user in the user's water conservation efforts. The waterflow notification data may request that the user provide the model of the plumbing fixture so that the waterflow analysis system can provide recommended models of plumbing fixtures to possibly replace an inefficient model.

In one embodiment, as will be set forth in more detail below, the waterflow analysis system 104 includes one or more analysis models that implement machine learning processes. The analysis models implement the machine learning processes to understand the plumbing circumstances of the user, to identify the types of plumbing fixtures monitored by the waterflow monitoring device 102, and to identify water conservation practices that can be implemented by the user based on the individual characteristics of the user and the user's plumbing circumstances.

In one embodiment, the user computing device 106 is a smart phone. The smart phone includes a waterflow analysis application associated with the waterflow analysis system 104. The waterfall analysis application displays the waterflow notification data to the user. The waterflow analysis application can also push notifications to the user even when the user is not actively using the waterflow analysis application. For example, the waterfall analysis application can cause the smart phone to output a notification sound. The waterflow analysis application can cause a notification icon to appear on a home screen of the smart phone. The waterflow analysis application can cause an LED or other visual indicator to blink or otherwise illuminates in order to indicate to the user that a waterflow notification is available to be viewed by the user.

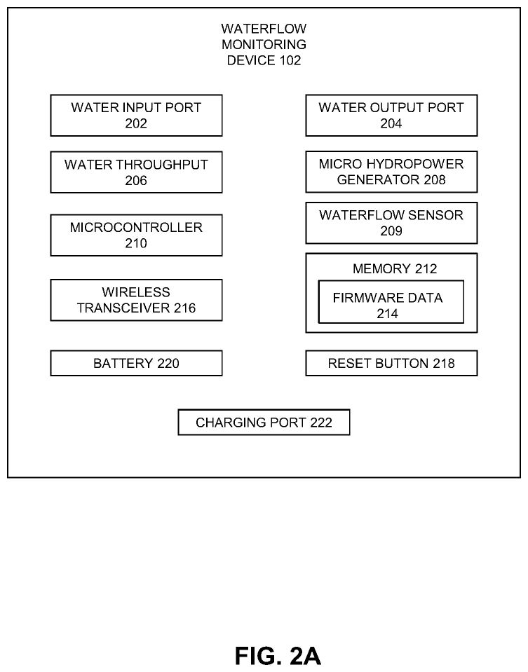

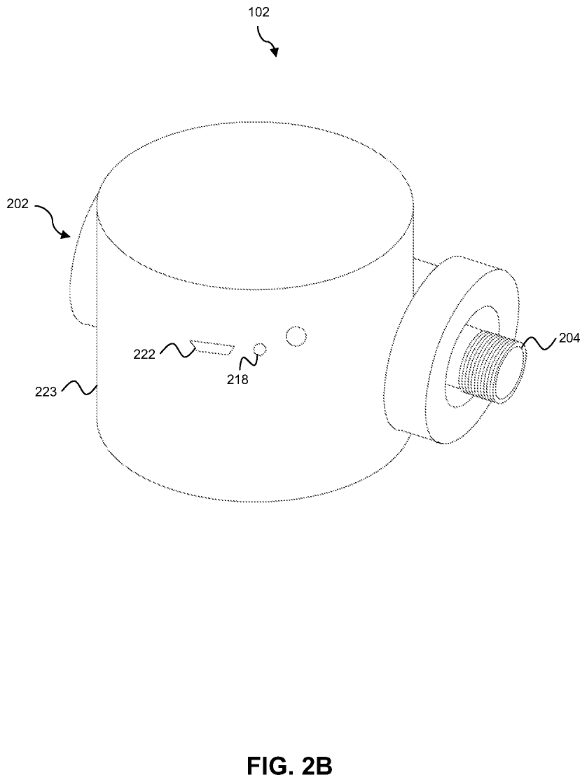

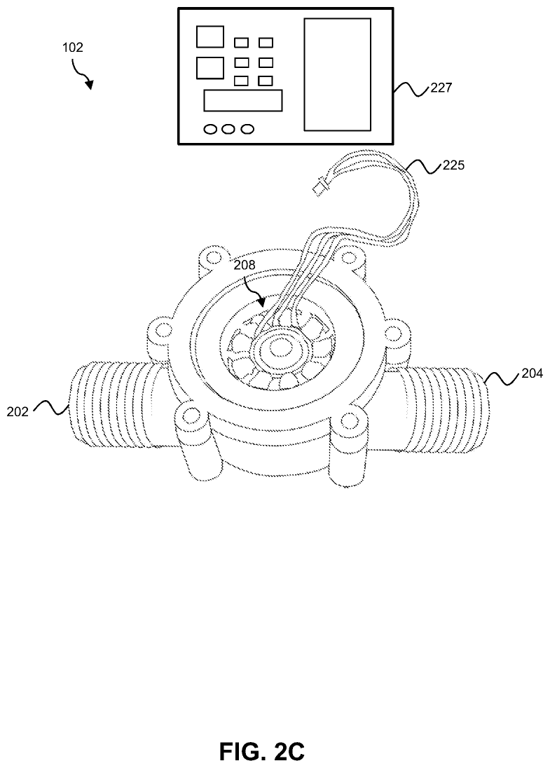

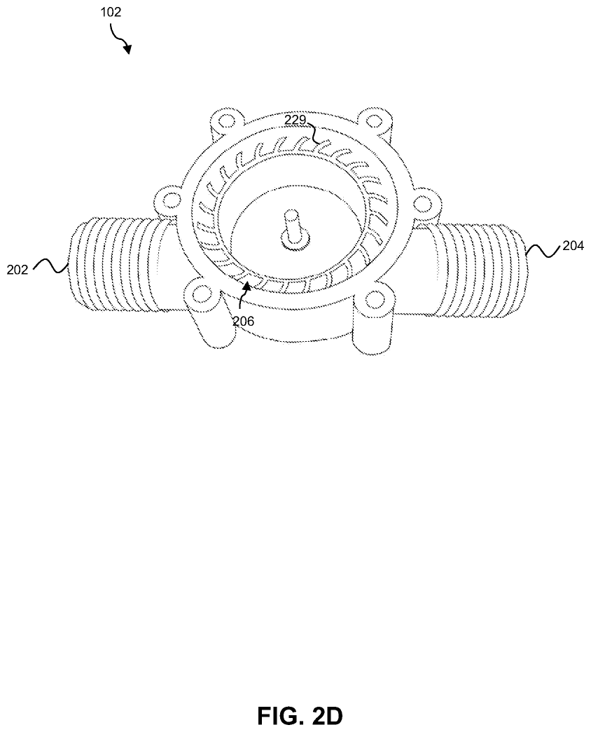

FIG. 2A is a block diagram of a waterflow monitoring device 102, according to one embodiment. The waterflow monitoring device 102 includes a water input port 202, a water output port 204, a water throughput 206, a micro hydropower generator 208, a waterflow sensor 209, a microcontroller 210, a memory 212, a wireless transceiver 216, a reset button 218, a battery 220, and a charging port 222, according to various embodiments. The components of the waterflow monitoring device 102 enable the waterflow monitoring device 102 to perform waterflow monitoring processes related to one or more plumbing fixtures and to provide waterflow monitoring data to a waterflow analysis system 104.

In one embodiment, the waterflow monitoring device 102 is configured to be installed in a plumbing system 108 upstream from one or more plumbing fixtures to be monitored by the waterflow monitoring device 102. For example, the waterflow monitoring device 102 can be disposed in the plumbing system as a portion of the plumbing system 108 through which water must flow in order to reach the one or more plumbing fixtures to be monitored by the waterflow monitoring device 102. Thus, any water that flows through the one or more plumbing fixtures to be monitored by the waterflow monitoring device 102 must first flow through the waterflow monitoring device 102. This enables the waterflow monitoring device 102 to perform accurate waterflow monitoring operations on the one or more plumbing fixtures.

In one embodiment, the waterflow monitoring device 102 includes an ultrasound waterflow sensor. The waterflow monitoring device 102 can be disposed in the plumbing system at a position external to a water pipe through which water flows to a plumbing fixture. The waterflow monitoring device 102 can use ultrasound waves to measure the flow of water through the water pipe. The waterflow monitoring device 102 can then output waterflow monitoring data to the waterflow analysis system for analysis.

In one embodiment, the waterflow monitoring device 102 utilizes the water input port 202 and the water output port 204 to connect into a plumbing system 108 upstream from the one or more plumbing fixtures to be monitored by the waterflow monitoring device 102. The water input port 202 can include a connection, such as a threaded connection, a water pipe connector, a water tube connector, or another kind of connector that enables the waterflow monitoring device 102 to be properly connected to a plumbing outlet from which the one or more plumbing fixtures receive water. The water output port 204 likewise includes a connection, such as a threaded connection, a water pipe connector, a water tube connector, or another kind of connector that enables the waterflow monitoring device to output water to the one or more plumbing fixtures to be monitored by the waterflow monitoring device 102.

In one example, in accordance with one embodiment, the waterflow monitoring device 102 is configured to be connected to a toilet to monitor waterflow through the toilet. Typically, toilets receive water from a plumbing outlet attached to or protruding from the bathroom wall. The water input port 202 is configured to be connected to the plumbing outlet attached to or protruding from the bathroom wall such that the waterflow monitoring device 102 receives water from the plumbing outlet. The water input port 202 can be configured to properly connect to a standard wall plumbing outlet. The water output port 204 is configured to attach to a water inlet of the toilet so that the waterflow monitoring device 102 can provide water to the toilet via the water output port 204. The water output port 204 can be configured to properly connect to a standard toilet inlet port. The water input port 202 and the water output port 204 can also be configured to be connected to hoses that can connect to the plumbing outlet and the inlet port of the toilet.

In one embodiment, the waterflow monitoring device 102 includes the water throughput 206. The water throughput 206 passes water from the water input port 202 to the water output port 204. Thus, any water that is supplied to the one or more plumbing fixtures passes through the water throughput 206. The throughput can include a copper plumbing pipe, a plastic plumbing pipe, a flexible funding tube, or other tubes or pipes that can be utilized in plumbing systems to pass water to a plumbing fixture. The water throughput 206, the water input port 202, and the water output port 204 can be a single unitary piece, in one embodiment. In other embodiments, the water input port 202, the water output port 204, and the water throughput 206 are separate parts that are securely connected together to pass water without leaking.

In one embodiment, the waterflow monitoring device 102 includes a micro hydropower generator 208. The micro hydropower generator 208 is connected to, or is part of, the water throughput 206. As water flows through the water throughput 206, the micro hydropower generator 208 generates electricity. The flowing water through the water throughput 206 causes a movable portion of the micro hydropower generator 208 to move, thereby causing the micro hydropower generator 208 to generate electricity.

In one embodiment, the waterflow monitoring device includes a waterflow sensor 209. The waterflow 209 sensor senses the flow of water through the water throughput 206. The waterflow sensor 209 can output waterflow signals indicating that water is flowing. The waterflow signals can also indicate the flow rate of the water. In one embodiment, the waterflow sensor includes components positioned within the water throughput 206 to sense waterflow. Alternatively, the waterflow sensor 209 senses waterflow without any components positioned in the water throughput 206. In one embodiment, if the waterflow sensor 209 is a purely external waterflow sensor, then the waterflow monitoring device 102 may not include the water input port 202, the water output port 204, the water throughput 206, and the micro hydropower generator 208.

In one embodiment, the micro hydropower generator 208 also corresponds to a waterflow sensor. The micro hydropower generator 208 senses waterflow through the water throughput 206. The micro hydropower generator 208 enables the waterflow monitoring system 102 to sense and monitor the flow of water through the water throughput 206. Accordingly, in one embodiment, the waterflow sensor 209 is part of the micro hydropower generator 208.

In one embodiment, the waterflow monitoring device includes a microcontroller 210 and a memory 212. The microcontroller 210 is configured to execute software instructions stored in the memory 212. In one embodiment, the memory 212 includes firmware data 214. The firmware data 214 corresponds to the basic operating instructions for the waterflow monitoring device 102. The microcontroller 210 executes the firmware data 214 and operates in accordance with the firmware data 214.

In one embodiment, the microcontroller 210 receives waterflow signals from the waterflow sensor 209. The waterflow signals are indicative of the flow of water through the water throughput 206. The microcontroller 210 generates waterflow monitoring data by processing the waterflow signals. The waterflow monitoring data includes the types of waterflow monitoring data described above, in a format that can be received and processed by the waterflow analysis system 104.

In one embodiment, the memory 212 also stores waterflow monitoring data prior to transmission of the waterflow monitoring data to the waterflow analysis system 104. The memory 212 can also store network connection data, and data related to the type or types of plumbing fixtures monitored by the waterflow monitoring device. In one embodiment, the memory 212 is part of the microcontroller 210. Alternatively, the memory 212 can be in a separate chip from the microcontroller 210.

In one embodiment, the waterflow monitoring device 102 includes a wireless transceiver 216. The wireless transceiver 216 is controlled by the microcontroller 210 in accordance with the firmware data 214. The wireless transceiver 216 is configured to make a network connection with a wireless network in the vicinity of the waterflow monitoring device 102. The wireless transceiver 216 can provide waterflow monitoring data to the waterflow analysis system 104 via the wireless network and other intervening networks. The wireless transceiver 216 can be configured to communicate via one or more wireless communication protocols including, but not limited to, a Wi-Fi protocol, a Bluetooth protocol, a ZigBee protocol, or a Z-Wave protocol.

In one embodiment, the waterflow monitoring device 102 includes a reset button 218. The reset button enables a user to either wake-up the microcontroller 210 or to reset the firmware data 214 to factory condition. For example, by pressing the reset button 218 for the first selected duration, the reset button can output an interrupt that wakes of the microcontroller 210. By pressing the reset button 218 for a second selected duration longer than the first selected duration, the reset button 218 can cause a factory reset of the firmware data 214. The reset button 218 can be positioned within a housing of the waterflow monitoring device 102 and can be accessible via a hole of relatively small diameter, for example the diameter of a common paperclip. Those of skill in the art will understand, in light of the present disclosure, that a reset button can be positioned or configured other than as described above without departing from the scope of the present disclosure.

In one embodiment, the waterflow monitoring device 102 includes a battery 220. The battery 220 can power the electronic components of the waterflow monitoring device 102. The battery 220 can include a rechargeable battery. The rechargeable battery can include a lithium-ion battery or other types of rechargeable batteries known in the art at the time of filing or such as may become known after the time of filing. In an alternative embodiment, the battery 220 can include a common replaceable battery that can be conveniently accessed and replaced by the user.

In one embodiment, the waterflow monitoring device 102 includes a charging port 222. The charging port 222 can receive a charging cable to recharge the battery 220, or to otherwise provide power to the electronic components of the waterflow monitoring device 102. The charging port 222 can include a micro USB port, a USB C port, a USB 2.0 port, a USB 3.0 port, or other types of charging ports known in the art at the time of filing or such as may a become known after the time of filing.

In one embodiment, the waterflow monitoring device 102 includes a casing or housing. The casing can include a durable material such as plastic or metal. The casing can enclose the electronic components such as the micro hydropower generator 208, the microcontroller 210, the memory 212, the wireless transceiver 216, the reset button 218, the battery 220. The charging port 222 can include an opening in the casing. The casing can also enclose entirely, or partially, the water throughput 206. In one embodiment, the casing is approximately spherical with a radius of about 7 cm. The casing can include a shapes other than spherical with a volume larger or smaller than the volume of the sphere of radius 7 cm.

In one embodiment, the waterflow monitoring device 102 has two modes, sleep mode and active mode. In order to more efficiently use the battery 220, the waterflow monitoring device 102 is most commonly in a sleep mode. Battery usage is minimal when the waterflow monitoring device 102 is in sleep mode. In one embodiment, bringing the waterflow monitoring device 102 into or out of sleep mode or active mode corresponds to bringing the microcontroller 210 into or out of sleep mode or active mode.

In one embodiment, there are three different ways to bring the waterflow monitoring device 102 out of sleep mode to active mode. Plugging the power cable into the charging port 222 can bring the waterflow monitoring device 102 out of sleep mode. When a charging cable is plugged into the charging port 222, the waterflow monitoring device 102 is brought to and stays in active mode indefinitely. After the charging cable is unplugged, the waterflow monitoring device 102 returns to sleep mode following the firmware signal.

In one embodiment, the waterflow monitoring device 102 can be brought out of sleep mode via the reset button 218. For example, inserting a paper clip into the hole in the casing that gives access to the reset button 218 and pressing the reset button can bring the waterflow monitoring device 102 out of sleep mode. The firmware then puts the waterflow monitoring device 102 back to sleep mode after firmware defined tasks have been completed.

In one example, in accordance with one embodiment, there are two different pushes of the reset button 218 that the waterflow monitoring device 102 accepts: a short push and a long push. The short push is defined by a push less than 2 seconds in length, in one embodiment. The short push brings the waterflow monitoring device 102 to active mode and allows the firmware to put it back to sleep mode, as will be set forth in more detail below. The long push is, for example, a push that is longer than 10 seconds in duration. The long push brings the waterflow monitoring device 102 back active mode and the firmware can detect the long push and reset the waterflow monitoring device 102 to the factory settings, according to one embodiment. Other lengths of time can be used without departing from the scope of the invention.

In one embodiment, the micro hydropower generator 208 can bring the waterflow monitoring device 102 out of sleep mode. In one embodiment, when the micro hydropower generator 208 detects waterflow it brings the waterflow monitoring device 102 out of sleep mode and sends the waterflow data to the firmware.

In one embodiment, the micro hydropower generator 208 performs three primary functions. The micro hydropower generator 208 can function as a waterflow sensor. The micro hydropower generator 208 can function as a device power supply. The micro hydropower generator 208 can function as a charging power source for the battery 220.

In one embodiment, the micro hydropower generator senses waterflow. When the micro hydropower generator 208 detects a waterflow, the micro hydropower generator 208 brings the waterflow monitoring device 102 out of sleep mode. The firmware takes over after the waterflow monitoring device 102 becomes active.

In one embodiment, the micro hydropower generator 208 acts as a power supply for the electronic components of the waterflow monitoring device 102 in certain circumstances. When the microcontroller 210 of the waterflow monitoring device 102 is started, the initial inrush current may be too much for the micro hydropower generator 208 to handle. However, after the initial inrush phase has passed, the micro hydropower generator 208 can generate enough power to support the waterflow monitoring device 102. The solution is to use the battery 220 if the micro hydropower generator 208 does not have enough power and to switch to micro hydropower generator 208 when the micro hydropower generator 208 is able to generate a sufficient amount of energy.

In one embodiment, the micro hydropower generator 208 acts as a charging source for the battery 220. After the initial inrush phase, the micro hydropower generator 208 can generate more power than the waterflow monitoring device 102 needs. Therefore, the waterflow monitoring device 102 uses the excess power generation to recharge the battery 220. With this design the battery power can last much longer.

In one embodiment, there are dual power suppliers inside of the waterflow monitoring device 102, the battery 220 and the micro hydropower generator 208. In one embodiment, there are three cases in which the waterflow monitoring device 102 is powered by the battery 220. The battery is used as the power device to cover the initial inrush current when the waterflow monitoring device 102 is powered on. After water flow has stopped, the battery 220 is used to send monitoring data to the waterflow analysis system 104 and to handle any response data from the waterflow analysis system 104. Additionally, if the waterflow pressure is too low, the micro hydropower generator 208 may not be able to generate enough power to power the waterflow monitoring device 102. In this case the battery 220 is used to power the entire process. On the other hand, if the water flow pressure is sufficient for the micro hydropower generator 208 to entirely power the waterflow monitoring device 102, the firmware switches to the micro hydropower generator 208 as the power source.

In one embodiment, the waterflow monitoring device 102 includes a valve that close off the water throughput 206 so that no water can flow to the plumbing fixture. In one embodiment, the valve can be electronically controlled by the microcontroller 210. The microcontroller can electronically close the valve using the battery 220 in order to prevent any water from flowing through the water throughput 206. In one embodiment, the waterflow analysis system 104 can send a command to the waterflow monitoring device to close the valve, for example when there is a leak detected by the waterflow analysis system 104 and the user has not responded waterflow notification data indicating that there is a leak.

In one embodiment, the user can input a command to the user computing device 106 to cause the waterflow monitoring device 104 to shut close the valve in order to stop waterflow in the event of a leak or other circumstances. For example, the user can access via the user computing device 106 a software application associated with the waterflow monitoring system 104 and can input a command to shut the valve and prevent further waterflow. The waterflow monitoring device receives the command either directly from the user computing device 106 or via the waterflow analysis system 104 and executes the command. In one embodiment the user computing device 106 is a smart phone. The software application can be an application implemented in the smart phone.

FIG. 2B is an illustration of a waterflow monitoring device 102, in accordance with one embodiment. The waterflow monitoring device 102 includes a casing 223. The charging port 222 is positioned on the casing such that a user can plug a charging cable into the charging port 222 to charge the battery of the waterflow monitoring device 102. The casing includes a relatively small opening through which the reset button 218 can be accessed by inserting a long thin instrument, such as a straightened paperclip. A threaded water output port 204 protrudes from the casing 223. A threaded water input port 202 also protrudes from the casing 223, though the elevated perspective view of FIG. 2B obscures the water input port 202. The threaded water input and output ports can be utilized to install the water monitoring device 102 in a plumbing system, for example, between a wall mounted bathroom water outlet and a toilet. In one embodiment, hoses can be utilized to connect the waterflow monitoring device 102 in the plumbing system.

In one embodiment, the water throughput 206 and the electrical components of the waterflow monitoring device 102 are positioned within the casing 223. The casing 223 can be made from a ceramic material, a plastic material, or another suitable material.

FIG. 2C is an illustration of components of a waterflow monitoring device 102 without the casing 223, in accordance with one embodiment. The view of FIG. 2C illustrates the micro hydropower generator 208. When water flows through the water input port 202 to the water output port 204 via the water throughput 206, the micro hydropower generator 208 generates electricity. The micro hydropower generator 208 can also act as a flow sensor that outputs sensor signals indicating that water is flowing, as well as the flow rate of the water. Alternatively, dedicated sensors can be positioned to sense one or more waterflow related parameters.

In one embodiment, the waterflow monitoring device 102 includes a printed circuit board 227. The printed circuit board 227 includes electrical components of the waterflow monitoring device 102. The printed circuit board 227 can include the microcontroller 210, the wireless transceiver 216, the memory 212, the reset button 218, and the battery 220, according to various embodiment. The micro hydropower generator 208 is coupled to the printed circuit board 227 via connector cables 225. The connector cables 225 can include power cables and signal cables. In one embodiment, the printed circuit board 227 is positioned within the casing 223.

FIG. 2D is an illustration of components of a waterflow monitoring device 102 with a portion of the micro hydropower generator 208 removed, in accordance with one embodiment. The view of FIG. 2D illustrates the water throughput 206 by which water flows from the water input port 202 to the water output port 204. A turbine wheel 229 of the micro hydropower generator 208 is positioned in the water throughput 206. When water flows through the water throughput 206, the flowing water turns the turbine wheel 229, causing the micro hydropower generator 208 to generate electricity. Additionally, or alternatively, the motion of the turbine wheel 229 can be utilized to sense the flow rate of the water, according to an embodiment. Those of skill in the art will recognize, in light of the present disclosure, that other types of micro hydropower generators 208 can be implemented without departing from the scope of the present disclosure.

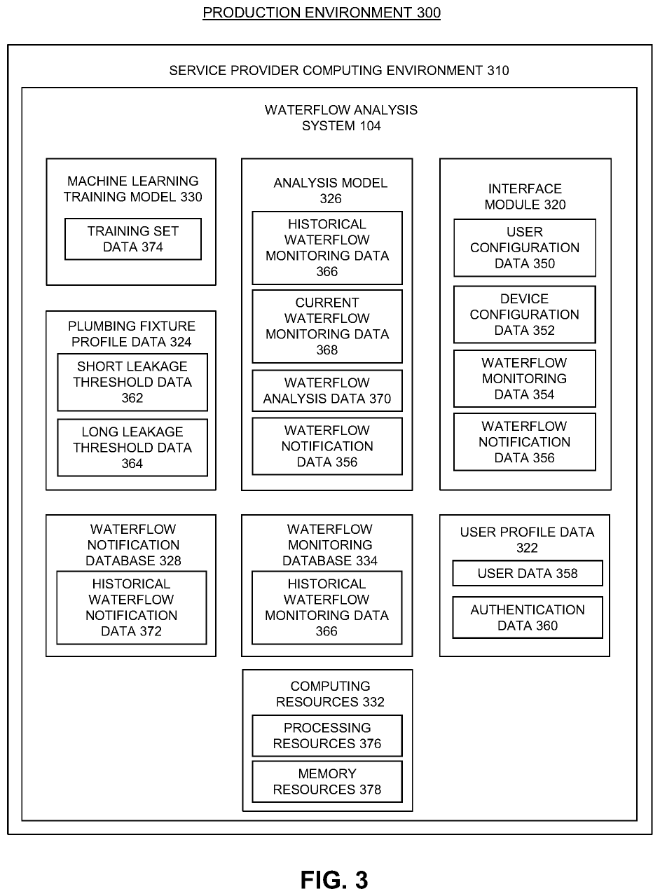

FIG. 3 is a block diagram of a production environment 300 for assisting users to conserve water, according to one embodiment. The production environment 300 includes a service provider computing environment 310 for assisting users to conserve water, according to various embodiments. The service provider computing environment 310 represents one or more computing systems such as a server or distribution center that is configured to receive, execute, and host one or more data management systems (e.g., applications) for access by one or more users, for predicting characteristics of transactions of users of a data management system, according to one embodiment. The service provider computing environment 310 represents a traditional data center computing environment, a virtual asset computing environment (e.g., a cloud computing environment), or a hybrid between a traditional data center computing environment and a virtual asset computing environment, according to one embodiment. The service provider computing environment 310 includes a waterflow analysis system 104, which is configured to assist user of the waterflow analysis system 104 to conserve water.

The waterflow analysis system 104 includes an interface module 320, user profile data 322, plumbing fixture profile data 324, an analysis model 326, a waterflow notification database 328, a machine learning training model 330, computing resources 332, and a waterflow monitoring database 334, according to various embodiments.

In one embodiment, the waterflow analysis system 104 utilizes the interface module 320 to communicate with the user computing device 106 and with the waterflow monitoring device 102. The interface module 320 can receive data from both the waterflow monitoring device 102 and the user computing device 106. The interface module 320 can output data to both the waterflow monitoring device 102 and the user computing device 106.

In one embodiment, when a user first purchases a waterflow monitoring device 102 and seeks to receive waterflow conservation assistance from the waterflow analysis system 104, the user must first register with the waterflow analysis system 104. In this case, the user can utilize the user computing device 106 to set up an account with the waterflow analysis system 104.

In one embodiment, when the user sets up an account with the waterflow analysis system 104, the user provides user configuration data 350 to the waterflow analysis system 104. Setting up an account can include providing account access credentials including a username, a password, and an email address. The user can then use these access credentials to log into the waterflow analysis system 104 in the future.

In one embodiment, the user configuration data 350 includes additional data about the user. The user configuration data 350 can include a name of the user, an address of the user, a geolocation of the user, and a telephone number of the user. The user configuration data 350 can also include data regarding whether water conservation assistance will be provided for a residential setting, a commercial setting, an educational setting, a government institution setting, a recreation setting, or other types of settings. The user configuration data 350 can also include payment data for providing payments to the waterflow analysis system 104.

In one embodiment, the user can provide device configuration data 352 to the waterflow analysis system 104 via the user computing device 106. The interface module 320 receives the waterflow monitoring device 102 configuration data 352. The waterflow monitoring device 102 configuration data 352 corresponds to characteristics regarding the waterflow monitoring device 102 that the user has installed or will install in the plumbing system 108. The waterflow monitoring device 102 configuration data 352 enables the waterflow analysis system 104 to activate the waterflow monitoring device 102, to receive data from the waterflow monitoring device 102, and to output data to the waterflow monitoring device 102.

In one embodiment, the waterflow monitoring device 102 configuration data 352 can include an identification number or serial number associated with the waterflow monitoring device 102 that is to be activated. The waterflow monitoring device 102 configuration data 352 can also include login credentials for a local network via which the waterflow monitoring device 102 will communicate with the waterflow analysis system 104. The identification number and serial number enable the waterflow analysis system 104 to authenticate and activate the waterflow monitoring device 102. The activation process can include the interface module 320 sending activation data to the waterflow monitoring device 102 via the one or more networks 110.

In one embodiment, the waterflow monitoring device 102 configuration data 352 can include data regarding a type of plumbing fixture that the waterflow monitoring device 102 will monitor. For example, the waterflow analysis system 104 can prompt the user, via the user computing device 106, to select from one or more types of plumbing fixtures. The plumbing fixture options can include a toilet, kitchen sink, a bathroom sink, a shower, a bathtub, a dishwasher, a washing machine, or other types of plumbing fixtures.

In one embodiment, after the user has selected the type of plumbing feature, the waterflow analysis system 104 can prompt the user to provide a brand of the plumbing fixture. The waterflow analysis system 104 can provide a list of known manufacturers. The waterflow analysis system 104 can then prompt the user to select a model of the plumbing fixture. If the brand or the model are not available as options presented by the waterflow analysis system 104, the user can manually enter the brand and model of the plumbing fixture.

In one embodiment, the waterflow monitoring device 102 configuration data 352 can include a number of people that may commonly use the plumbing fixture. For example, if the plumbing fixture is enabled residential location, then the waterflow monitoring device 102 configuration data 352 can include a number of people that live at the residence.

In one embodiment, once the waterflow monitoring device 102 has been installed and activated, the waterflow analysis system 104 receives waterflow monitoring data 354 from the waterflow monitoring device 102. The waterflow monitoring data 354 indicates characteristics of the flow of water through the plumbing fixture monitored by the waterflow monitoring device 102. The waterflow monitoring data 354can include a time periods or lengths of time during which water flowed through the plumbing fixture. The waterflow monitoring data 354 can include flow rates of the water through the plumbing fixture during the times that water flowed through the plumbing fixture. The flow rate data can include dates and times of waterflow. The waterflow monitoring data 354 can include ranges of time during which water flowed. The waterflow monitoring data 354 can include other kinds of data indicative of water use in waterflow through the plumbing fixture, as will be apparent to those of skill in the art in light of the present disclosure.

In one embodiment, the interface module 320 outputs waterflow notification data 356 to the user computing device 106 so that the user computing device 106 can display the waterflow notification data 356 to the user. The waterflow notification data 356 can include analysis generated by the waterflow analysis system 104 based on the waterflow monitoring data received from the waterflow monitoring device 102, as will be described in more detail below. The waterflow notification data 356 can include data indicating how much water is used by the plumbing fixture monitored by the waterflow monitoring device 102, how often water flows through the plumbing fixture, times of day that water flows through the plumbing fixture, aggregated data reflecting waterflow over a particular time period, comparison data indicating how much water was used in one aggregation period versus another aggregation period, changes in waterflow patterns, or other types of waterflow analysis.

In one embodiment, the waterflow notification data 356 includes one or more recommended actions to be taken by the user. For example, the waterflow notification data 356 can indicate that there is likely a leak associated with the one or more water fixtures based on the waterflow monitoring data. The waterflow notification data 356 can encourage the user to check for a leak or replace a plumbing fixture. The waterflow notification data 356 can recommend to the user ways that the user could better conserve water based on the analysis of the waterflow monitoring data 354.

In one embodiment, the user can install multiple waterflow monitoring devices 102. The user can configure and activate each waterflow monitoring device 102 with the waterflow analysis system 104. Each activated waterflow monitoring device 102 is linked to the account of the user. Each waterflow monitoring device 102 provides waterflow monitoring data 354 to the waterflow analysis system 104. The waterflow analysis system 104 provides waterflow notification data 356 to the user regarding each installed waterflow monitoring device 102. Thus, although the description of the waterflow analysis system 104 is set forth primarily with regards to a single waterflow monitoring device 102, the waterflow analysis system 104 can perform the described functions for multiple waterflow monitoring devices 102 for each user of the waterflow analysis system 104.

In one embodiment, the waterflow analysis system 104 includes user profile data 322. The user profile data 322 includes user data 358. The user data 358 can include the data provided by the user with the user configuration data 350. The user data 358 can include a name of the user, a location of the user, a number of waterflow monitoring devices 102 associated with the user, the type of account that the user has with the waterflow analysis system 104, payment data of the user, or other data provided by the user or collected related to the user. The user profile data 322 can also include authentication data 360 corresponding to the login credentials of the user for accessing the waterflow analysis system 104.

In one embodiment, the waterflow analysis system 104 also includes plumbing fixture profile data 324. The plumbing fixture profile data 324 corresponds to the characteristics of the plumbing fixture associated with the waterflow monitoring device 102. The plumbing fixture profile data 324 can include data indicating the type of the plumbing fixture, the brand of the plumbing fixture, and the model of the plumbing fixture. The plumbing fixture profile data 324 can also include data generated by the waterflow analysis system 104 related to the plumbing fixture based on analysis of the waterflow monitoring data 354. In one embodiment, the plumbing fixture profile data 324 can include short leakage threshold data 362 and long leakage threshold data 364, as will be described in more detail below.

In one embodiment, the waterflow analysis system 104 includes a waterflow monitoring database 334. The waterflow monitoring database 334 includes historical waterflow monitoring data 366. The historical waterflow monitoring data 366 includes all of the waterflow monitoring data 354 collected by the waterflow analysis system 104 from the waterflow monitoring device 102. As new waterflow monitoring data 354 is received from the waterflow monitoring device 102, the historical waterflow monitoring data 366 is updated.

In one embodiment, the waterflow analysis system 104 includes an analysis model 326. The analysis model 326 is configured to analyze the waterflow monitoring data 354. The analysis model 326 generates waterflow notification data 356 based on the waterflow monitoring data 354.

In one embodiment, the analysis model 326 is trained with a machine learning process to identify characteristics of the plumbing fixture associated with the waterflow monitoring device 102 based on the waterflow monitoring data 354. The machine learning process trains the analysis model 326 based on the known waterflow characteristics of a large database of plumbing fixtures. The machine learning process trains the analysis model 326 based on the known characteristics of plumbing fixtures and the known waterflow monitoring data associated with other users of the waterflow analysis system 104.

In one embodiment, the analysis model 326 is trained by the machine learning process to learn the characteristics of the plumbing fixture and the usage habits of those that use the plumbing fixture. The analysis model 326 is trained to determine when the plumbing fixture is likely leaking and to generate waterflow notification data 356 indicating to the user that the plumbing fixture is likely leaking. The analysis model 326 is trained to determine whether better conservation habits on the part of the user can reduce the amount of waterflow through the plumbing fixture and to generate waterflow notification data 356 indicating overuse of the plumbing fixture and tips for conserving water.

In one embodiment, the analysis model 326 utilizes historical waterflow monitoring data 366 when learning the characteristics of the plumbing fixture and when determining waterflow notification data 356 to be sent to the user. The historical waterflow monitoring data 366 analyzed by the analysis model 326 can include waterflow monitoring data from a selected time period, such as the previous week, the previous month, or the entirety of the historical waterflow monitoring data received from the waterflow monitoring device 102.

In one embodiment, the analysis model 326 also utilizes the most current waterflow monitoring data 368 when learning the characteristics of the plumbing fixture when determining waterflow notification data 356 to be sent to the user. For example, the analysis model 326 can compare the current waterflow monitoring data 368 to the historical waterflow monitoring data 366 in order to generate waterflow analysis data 370. The analysis model 326 can utilize the waterflow analysis data 370 to update the characteristics of the plumbing fixture and to generate waterflow notification data 356 to be sent to the user.

In one nonlimiting example of operation of the waterflow analysis system 104, the plumbing fixture monitored by the waterflow monitoring device 102 is a toilet. Knowing the average time needed to fill the water tank per normal flush for each individual toilet can be very helpful in providing useful waterflow notification data 356 to the user. With this data, the analysis model 326 can detect water waste and notify the user regarding how to use the toilet more efficiently.

Individual toilets can have widely varying characteristics. For example, different models of toilets can have different sizes of water tanks. The size of the water tank can determine both how much water is used for flush and how long it takes to refill the tank. To assist in water conservation, some toilets include dual flush buttons that enables selective flushing for purely liquid waste or combinations of solid and liquid waste. The same model of toilet installed in different locations can have different durations to fill the water tank. For example, at the top of a high-rise building it can take longer to fill the tank because the water pressure can be lower than at lower levels. Because of wear and tear, the duration of filling up the water tank can change after years of use. Additionally, people can add objects into the water tank to take away some volume of the water tank in order to conserve water. Accordingly, the water use characteristics of individual toilets can vary widely even before accounting for the particular habits of users.

The water monitoring system 104 utilizes the analysis model 326, the firmware data 214 of the waterflow monitoring device 102, and the user computing device 106 to assist users to conserve water. The firmware data 214 acts as an executor that executes rules pushed down from the waterflow analysis system 104 and uploads the waterflow monitoring data 354 to the waterflow analysis system 104 based on the rules. The user computing device 106, for example a mobile phone, acts as a deliverer or notifier that delivers alerts in a timely manner so that users can react accordingly. The analysis model 326 is the brain that analyzes the waterflow monitoring data 354 and generates the waterflow notification data 356.

In one embodiment, one function of the analysis model 326 is to detect whether there is a water leak in the toilet. Before the analysis model 326 can detect leaking water, it will determine the average time taken to fill the water tank per normal flush. After the analysis model 326 has determined the average refill time for a flush, the analysis model 326 can determine one a leakage has occurred. In one alternate embodiment, the waterflow monitoring device 102 can calculate the average time for a flush and provide that data to the waterflow analysis system 104 with the waterflow monitoring data 354.

In one embodiment, there are two type of the water leakages that can be detected by the analysis model 326: a long water leakage and a short water leakage. The long water leakage can correspond to waterflow to the toilet that continues for a duration of time longer than 3 times the average water tank refill time. Other thresholds other than a factor of three can be utilized to detect long water leakage. A short water leakage can correspond to more than 50% of the last N flushes using less than half of the average time, where N is a selected number of flushes. A short water leakage can occur when the rubber flipper in the toilet tank fails to seal the drainage. Other thresholds can be used to determine that a short water leakage has occurred.

In one embodiment, after a new water monitoring device 102 has been installed to monitor toilet, there can be multiple phases using different algorithms to calculate the average time for a flush. In one example, there are three different phases using different algorithms to calculate the average time for flush: a beginning phase, and learning phase, and an advanced phase. Those of skill in the art will recognize, in light of the present disclosure, that a waterflow monitoring device 102 can utilize fewer or more phases than three, without departing from the scope of the present disclosure.

In one embodiment, the beginning phase corresponds to a phase in which the waterflow monitoring device 102 has been newly installed. Because the waterflow monitoring device 102 has been newly installed, there is no previous data that can be used to calculate the average time per flush. In one example, a default average time is selected. The default average time can be a duration that is longer than most toilet flush refills. In one example, the initial default average time can be two minutes. In this case, the long water leakage would take six minutes to be determined and reported to the user, if the long water threshold is three times the average flush duration.

In one embodiment, in the learning phase, some simple calculations can be used to determine the average flush refill time. After a selected number of flush refill times have been observed, the average time can be calculated based on the observed flush refill times. The learning phase can include sorting the observed flush refill times from shortest to longest, excluding detected leakages. The learning phase then normalizes the observed flush refill durations by taking off 20% from the longest waterflow and 20% from the shortest waterflow from the sorted data points. After more data points are collected, for example, more than 20 data points, the average time can be calculated. The reason to do this is that users flush manually, and individual pushes on the flush button or lever are not consistent. With the remaining 60% of the middle section of the sorted data points, a simple calculation can be performed to determine the average, for example by summing the durations and dividing by the number of data points. Those of skill in the art will recognize, in light of the present disclosure, that other algorithms or methods can be used to determine an average flush time during the learning phase without departing from the scope of the present disclosure.

In one embodiment, in the advanced phase begins after a selected number of months, for example 3, or after a selected number of toilet flushes have been observed, for example 100. With the larger pool of data points, the normal distribution (bell curve) of statistics is used to calculate the probability of the recent water flow data. By using the normal distribution calculation, the advanced phase calculates the standard deviation of toilet flush durations based on the pool of recent data points. The first standard deviation has about 68.52% of the data points. The average time is calculated based on this 68.52% of the data points. The standard deviation can be recalculated periodically, for example, weekly or monthly.

In one embodiment, the plumbing fixture profile data 324 includes the short leakage threshold data 362 indicating the short leakage threshold determined based on the calculated average toilet flush and selected factors as set forth above. The plumbing fixture profile data 324 also includes long leakage threshold data 364 indicating the long leakage threshold. The long leakage threshold data 364 includes the long leakage threshold data calculated based on the average flush duration and other factors as set forth above. The analysis model 326 can determine a leak by comparing one or more recent observed flush durations to the short leakage threshold and the long leakage threshold. The analysis model 326 can generate waterflow notification data 356 indicating that there is a leak. The waterflow notification data 356 is sent to the user computing device 106 so that the user can observe the notification and take action.

In one embodiment, the waterflow notification data 356 can include messages congratulating the user on water conservation steps taken by the user, such as reducing the volume of the toilet water tank. The waterflow notification data 356 can encourage users to take water conservation measures based on the analysis of the waterflow monitoring data 354.

While a particular example has been described in which a waterflow monitoring device 102 is installed to monitor a toilet, those of skill in the art will recognize, in light of the present disclosure, that the waterflow monitoring device 102 and the analysis model 326 can analyze water usage and generate waterflow notification data 356 for other types of plumbing fixtures. Using the principles set forth above, the analysis model 326 can learn the behaviors and characteristics of other plumbing fixtures, identify leaks in other plumbing fixtures, identify wasteful use of other plumbing fixtures, identify abnormal use of other plumbing fixtures, and provide alerts, advice, and encouragement in the waterflow notification data 356.

In one embodiment, the waterflow analysis system 104 utilizes the machine learning training module 330 to train the analysis model 326 in accordance with one or more machine learning processes. The machine learning training module 330 trains the analysis model 326 with one or more machine learning process to identify characteristics of the plumbing fixture associated with the waterflow monitoring device 102 based on the waterflow monitoring data 354. The machine learning process trains the analysis model 326 based on the known waterflow characteristics of a large database of plumbing fixtures. The machine learning process trains the analysis model 326 based on the known characteristics of plumbing fixtures and the known waterflow monitoring data associated with other users of the waterflow analysis system 104.

In one embodiment, the machine learning training module 330 can utilize training set data 374 to train the analysis model 326 in accordance with a supervised machine learning process. The training set data 374 can include the known characteristics of various brands and models of plumbing fixtures. For toilets, the training set data could include average tank sizes, average flush times, leakage rates, and types of flushing mechanisms. The training set data 374 can also include the observed usage habits of a large variety of users that have use the various plumbing fixtures. Based on the training set data, the machine learning training module 330 can train the analysis model 326 to identify or predict characteristics of plumbing fixtures and predicted usage based on typical usage patterns of users who have used those plumbing fixtures.

In one embodiment, the analysis model 326 includes a logistic regression model. In one embodiment, the analysis model 326 includes a random forest model. In one embodiment, the analysis model 326 includes a linear regression model. In one embodiment, the analysis model 326 includes a linear discriminant model. In one embodiment, the analysis model 326 includes a neural networks model. In one embodiment, the analysis model 326 includes a support vector machines model. In one embodiment, the analysis model 326 includes a decision tree model. In one embodiment, the analysis model 326 utilizes a latent Dirichlet allocation (LDA) model. In one embodiment, the analysis model 326 includes a naïve Bayes model. In one embodiment, the analysis model 326 includes a K nearest neighbors model. Additionally, or alternatively, the analysis model 326 can utilize other types of models or algorithms, as discussed herein, and/or as known in the art at the time of filing, and/or as becomes known after the time of filing.

In one embodiment, the analysis model 326 utilizes both supervised and unsupervised machine learning. The unsupervised learning includes, in one embodiment, one or more of an LDA model, a probabilistic topic model, a clustering model, or other kinds of unsupervised learning. The supervised learning includes, in one embodiment, a multiclass classifier or another kind of supervised learning model.

In one embodiment, the analysis model 326 includes a recurrent neural network. The recurrent neural network can include a plurality of nodes. Connections between the nodes form a directed graph along a sequence. The recurrent neural network can exhibit dynamic temporal behavior for a time sequence. The recurrent neural network can use its internal memory to process sequences of inputs. In one embodiment, the recurrent neural network is an attention based recurrent neural network.

In one embodiment, the waterflow analysis system 104 includes a waterflow notification database 328. The waterflow notification database 328 includes historical waterflow notification data 372 including waterflow notifications that have been sent to users in the past.

In one embodiment, the computing resources 332 include processing resources 376 and memory resources 378. The processing resources 376 include one or more processors. The memory resources 378 include one or more memories configured as computer readable media capable of storing software instructions and other data. The processing resources 376 are capable of executing software instructions stored on the computer readable media. In one embodiment, the various components, models, modules, databases, and engines of the waterflow analysis system 104 utilize the computing resources 332 to assist in performing their various functions. Alternatively, or additionally, the various components, modules, databases, and engines can utilize other computing resources.

In one embodiment, the user computing device is a smart phone. The smart phone includes the waterflow analysis application associated with the waterflow analysis system 104. The user accesses the waterflow analysis application to connect the waterflow monitoring device 102 to a local communication network, such as a wireless communication network. The user uses the waterflow analysis application to communicate with the waterflow analysis system, for example to set up an account with the waterflow analysis system, to configure waterflow notification devices, and to receive waterflow notification data 356 from the waterflow analysis system 104. The smart phone can include computing resources including processing resources and memory resources to execute the application. In one embodiment, portions of the waterflow analysis system 104 can be implemented within the waterflow analysis application.

In one embodiment, the user can utilize multiple user computing devices to communicate with the waterflow analysis system 104. For example, the user can use multiple desktop computers, laptop computers, tablets, smart phones, and wearable devices as user computing devices 106 to access the waterflow analysis system 104 to receive waterflow analysis services.

In one embodiment, a waterflow monitoring device 102 needs a stable power supply to work properly. In the most of house of US there is no power outlet next a toilet. Using an external standard USB charger may not be a good idea in this case. Another choice would be using batteries. Since the battery power wouldn't last very long and changing batteries is not very convenient in the location in which the waterflow monitoring device 102 is installed. Therefore, at the initial design phase, one of the preferred specifications is that the power supply has to last at least 6 months without replacing or recharging, if not longer.

In one embodiment, the waterflow monitoring device 102 can be equipped with a micro hydropower generator. Compatible micro hydropower generators can be bought off the shelf or purchased online. In one embodiment, a micro hydropower generator can provide about 0.3 watts power with a tap water pressure of 60 psi. Thus, in one embodiment, a micro hydropower generator can handle 60 mA at 5 V with 60 psi pressure. Those of skill in the art will understand, in light of the present disclosure, that a micro hydropower generator can have different operating specifications and characteristics than those described above without departing from the scope of the present disclosure.

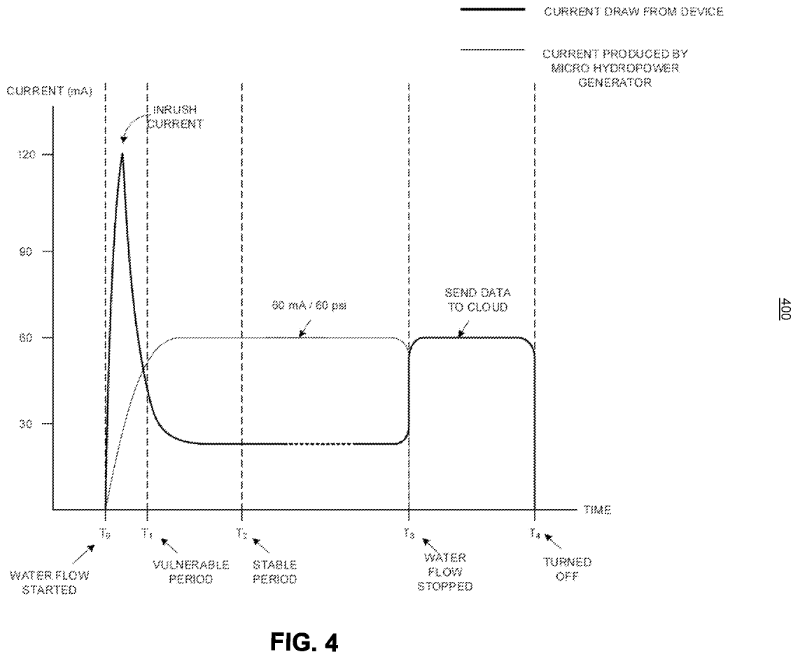

FIG. 4 is a graph 400 illustrating current draw from a waterflow monitoring device and current produced by a micro hydropower generator, in accordance with one embodiment.

In one embodiment, at time T0 waterflow begins, for example when a toilet is flushed. T1 corresponds to a time at which current generation and current draw are unstable. T2 corresponds to a stable period during which current draw and current generation are stable. T3 corresponds to a time when waterflow is stopped, for example, when a toilet water tank is full. T4 corresponds to a time at which the waterflow monitoring device 102 is turned off or enters sleep mode.

In one embodiment, When waterflow starts and the microcontroller wakes up at T0, there is a current inrush. During the current inrush, the waterflow monitoring device 102 needs a relatively high amount of power to operate. After about a little less than one second, the microcontroller operation becomes steady and the power consumption is reduced dramatically. After the waterflow stops, the waterflow monitoring device 102 needs to transmit waterflow monitoring data wirelessly to the waterflow analysis system 104, thereby requiring another relatively power consumption until the completion of the process.

Accordingly, in one embodiment, there is a power ramp up at the initial wake-up and during the transmission of the waterflow monitoring data.

In one embodiment, there are four power consumption periods during the entire process. During the circuit inrush period the micro hydropower generator is just ramping up and can't support the waterflow monitoring device 102. The waterflow monitoring device 102 can depend on the battery to run. The second period is called the vulnerable period because the micro hydropower generator is still not stable. The battery is still a better option. The third period is called the stable period because current draw and current generation are stable. As can be seen from the graph 400, if the water pressure is high enough, the micro hydropower generator can not only provide the power that the waterflow monitoring device 102 needs during this stable period, there is also some extra power which can be used to recharge the battery.

In one embodiment, when the water flow stops the situation is changed. The waterflow monitoring device 102 can't turn off the power at the moment because the data needs to be sent to the cloud services. Because there is no power from the micro hydropower generator anymore, everything relies on the battery again. Accordingly, three out of four periods depend on the battery power.

In one embodiment, there is only one period during which the micro hydropower generator generates sufficient power consistently to power the device. If this period can generate more power than the other three periods spend, the device in theory can be run without external power for a very long time. If the water pressure is not high enough, then the micro hydropower generator can't generate enough power to meet the needs of the waterflow monitoring device 102. In this situation, using an external charger may be the only choice remaining.

In one embodiment, during this whole process there are a couple of key moments, T0, T2, T3 and T4. In one embodiment, the process starts at T0. At T2 the logic circuit and the firmware work together to flip the power source of the waterflow monitoring device 102 from the battery to the micro hydropower generator if the micro hydropower generator generates enough power. In one embodiment, the flip happens only when both following conditions are true: the firmware sends the flipping signal to the logic circuit after waiting from T0 to T2 and the logic circuit detects the micro hydropower generator voltage is 4.2 V or higher after applying the load. At T3, since the micro hydropower generator stops generating power, the logic circuit detects 0 V. The logic circuit flips back to battery. At T4, the firmware has completed all tasks. It sends the turn-off signal to the latching circuit to bring the waterflow monitoring device 102 back to sleep mode.

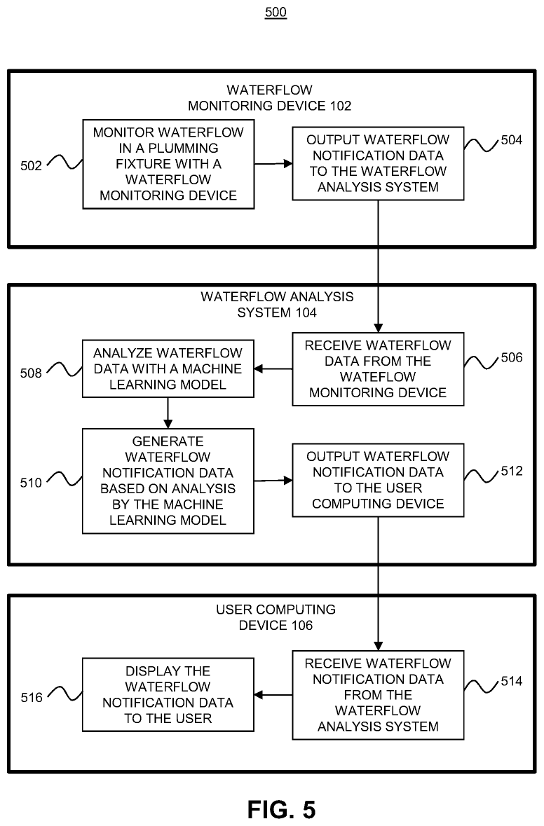

FIG. 5 illustrates a functional flow diagram of a process 500 for assisting users to conserve water, in accordance with one embodiment. The process 500 can complete the various process steps using any of the methods, processes, and procedures discussed above with respect to FIGS. 1-4.

Referring to FIG. 5, and the description of FIGS. 1-4 above, at block 502 the waterflow monitoring device 102 monitors waterflow in a plumbing fixture with a waterflow monitoring device, according to one embodiment. From block 502 the process proceeds to block 504.

At block 504 the waterflow monitoring device 102 outputs waterflow notification data to the waterflow analysis system, according to one embodiment. From block 504 the process proceeds to block 506.

At block 506 the waterflow analysis system 104 receives waterflow data from the waterflow monitoring device, according to one embodiment. From block 506 the process proceeds to block 508.

At block 508 the waterflow analysis system 104 analyzes waterflow data with a machine learning module, according to one embodiment. From block 508 the process proceeds to block 510.

At block 510 the waterflow analysis system 104 generates waterflow notification data based on analysis by machine learning module, according to one embodiment. From block 510 the process proceeds to block 512

At block 512 the waterflow analysis system 104 outputs waterflow notification data to the user computing device, according to one embodiment. From block 512 the process proceeds to block 514.

At block 514 the user computing device 106 receives waterflow notification data from the waterflow analysis system, according to one embodiment. From block 514 the process proceeds to block 516.

At block 516 the user computing device 106 displays the waterflow notification data to the user, according to one embodiment.

Those of skill in the art will recognize, in light of the present disclosure, that the process 500 can include different steps and different orders of steps, other than those represented in FIG. 5 without departing from the scope of the present disclosure.

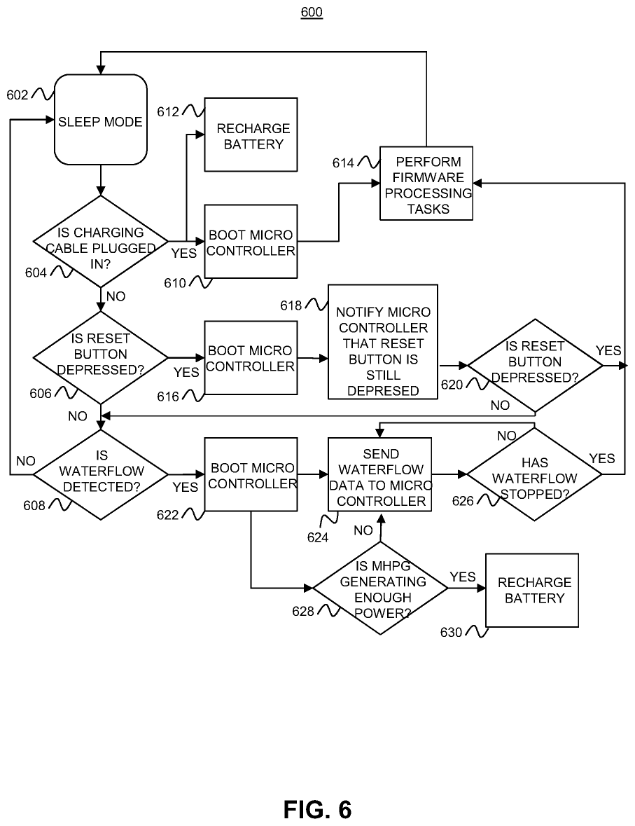

FIG. 6 illustrates a functional flow diagram of a process 600 corresponding to a hardware logic flowchart for a waterflow monitoring device 102, in accordance with one embodiment. The process 600 can complete the various process steps using any of the methods, processes, and procedures discussed above with respect to FIGS. 1-5.

Referring to FIG. 6, and the description of FIGS. 1-4 above, at block 602 the waterflow monitoring device 102 is in sleep mode, according to one embodiment. The process proceeds from block 602 to block 604.

At block 604 if the charging cable is plugged in to the waterflow monitoring device 102, the process proceeds to block 610 and 612. At block 610 the microcontroller is booted, according to one embodiment. At block 612 the battery is recharged, according to one embodiment. From block 610 the process proceeds to block 614. At block 614 firmware processing tasks are performed, according to one embodiment.

At block 604 if the charging cable is not plugged in, the process proceeds to block 606. At block 606 if the reset button is depressed, the process proceeds to block 616, according to one embodiment. At block 616 the microcontroller is booted, according to one embodiment. From block 616 the process proceeds to block 618. At block 618 the microcontroller is notified that the reset button is still depressed, according to one embodiment. If at block 620 the reset button is still depressed, then the process proceeds to block 614, according to one embodiment. If at 620 the reset button is no longer depressed, then the process proceeds to block 608, according to one embodiment.

At block 606, if the reset button is not depressed, then the process proceeds to block 608, according to one embodiment. If at block 608 waterflow is not detected, then the process proceeds to block 602, according to one embodiment. If at block 608 waterflow is detected, then the process proceeds to block 622, according to one embodiment. At block 622, the microcontroller is booted, according to one embodiment. From block 622, the process proceeds to block 624 and 628. At block 624 waterflow data is sent to the microcontroller, according to one embodiment. From block 624 the process proceeds to block 626. At block 626, if the waterflow has not stopped the process proceeds to block 624, according to one embodiment. At block 626 if the waterflow has stopped, then the process proceeds to block 614. At block 628 if the micro hydropower generator is generating enough power, then the process proceeds to block 630, according to one embodiment. At block 630 the battery is recharged by the micro hydropower generator, according to one embodiment. At block 628 if the micro hydropower generator is not generating enough power, the process proceeds to block 624.

Those of skill in the art will recognize, in light of the present disclosure, that the process 600 can include different steps and different orders of steps, other than those represented in FIG. 6 without departing from the scope of the present disclosure.

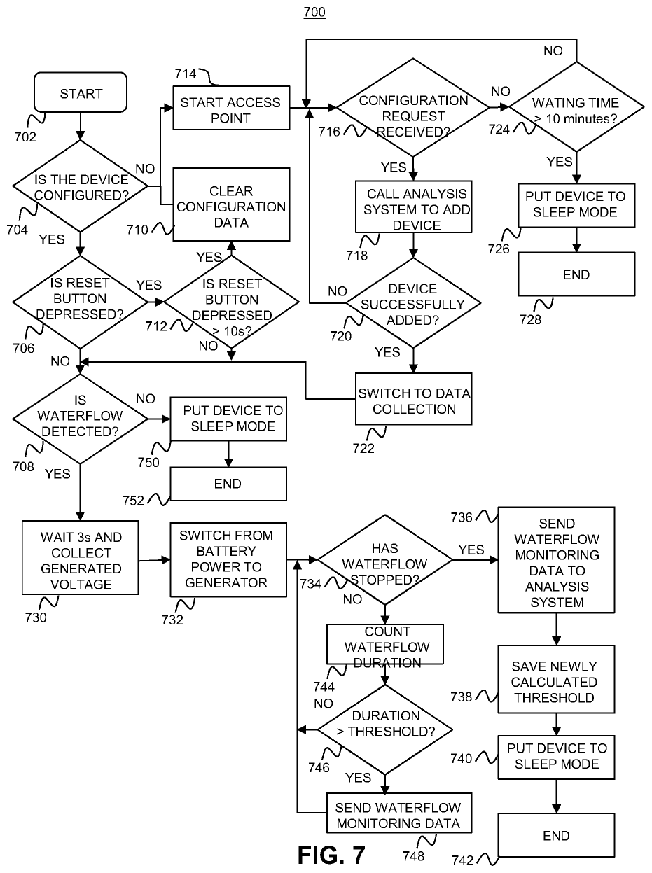

FIG. 7 illustrates a functional flow diagram of a process 700 corresponding to a firmware logic flowchart for a waterflow monitoring device 102, in accordance with one embodiment. The process 700 can complete the various process steps using any of the methods, processes, and procedures discussed above with respect to FIGS. 1-6.

Referring to FIG. 7, and the description of FIGS. 1-4 above, at block 702 the process starts, according to one embodiment. From block 702 the process proceeds to block 704. At block 704 if the waterflow monitoring device 102 is not configured that the process proceeds to block 714, according to one embodiment. From block 714 the process proceeds to block 716. At block 716, if a configuration request is received, then the process proceeds to block 718, according to one embodiment. At block 718 the waterflow analysis system is called to add the waterflow monitoring device 102, according to one embodiment. At block 720, if the waterflow monitoring device 102 has been added successfully, then the waterflow monitoring device 102 switches to a data collection operation at block 722, according to one embodiment. From block 722, the process proceeds to block 708, according to one embodiment. If at block 720 the waterflow monitoring device 102 is not successfully added, then the process returns to block 716. At block 716 if a configuration request is not received, then the process proceeds to block 724, according to one embodiment. At block 724, if the waiting time has exceeded 10 minutes, then the process proceeds to block 726. At block 726, the waterflow monitoring device 102 is put into sleep mode, according to one embodiment. From block 726 the process proceeds to block 728. At block 728 the process ends. At block 724, if the waiting time does not exceed 10 minutes, then the process returns to block 716, according to one embodiment.

At block 704, if the waterflow monitoring device 102 is configured, then the process proceeds to block 706. At block 706, if the reset button is depressed, then the process proceeds to block 712. If at block 712 the reset button has been depressed for longer than 10 seconds, then the process proceeds to block 710. At block 710, the configuration data is cleared and the firmware is reset to factory condition, according to one embodiment. From block 710 the process proceeds to block 714. If at block 712 the reset button is not depressed longer than 10 seconds, then the process proceeds to block 708.

At block 706, if the reset button is not depressed, then the process proceeds to block 708. At block 708, if waterflow is not detected, then the process proceeds to block 750. At block 750, the waterflow monitoring device 102 is put into sleep mode, according to one embodiment. From block 750, the process proceeds to block 752. At block 752 the process ends, according to one embodiment.

If at block 708 waterflow is detected, then the process proceeds to block 730. At block 730, the process waits, for three seconds, for example, and then collects voltage generated by the micro hydropower generator, according to one embodiment. From block 730 the process proceeds to block 732. At block 732, the data flow monitoring device 102 switches from being powered by the battery to being powered by the micro hydropower generator, according to one embodiment. From block 732 the process proceeds to block 734. At block 734 if the waterflow has stopped, then the process proceeds to block 744. At block 744, the waterflow duration is counted, according to one embodiment. From block 744 the process proceeds to block 746. At block 746, if the waterflow duration is greater than a threshold, then the process proceeds to block 748. At block 748, waterflow monitoring data is sent to the waterflow analysis system 104, according to one embodiment. From block 748 the process returns to block 734. If at block 746 the duration of the waterflow is less than a threshold, the process returns to block 734.

At block 734 if the waterflow has stopped, then the process proceeds to block 736. At block 736, waterflow monitoring data is sent to the waterflow analysis system 104, according to one embodiment. From block 736 the process proceeds to block 738. At block 738, newly calculated threshold data is saved, according to one embodiment. From block 738 the process proceeds to block 740. At block 740, the waterflow monitoring device 104 is put into sleep mode, according to one embodiment. From block 740 the process proceeds to block 742. At block 742 the process ends, according to one embodiment.

Those of skill in the art will recognize, in light of the present disclosure, that the process 700 can include different steps and different orders of steps, other than those represented in FIG. 7 without departing from the scope of the present disclosure.

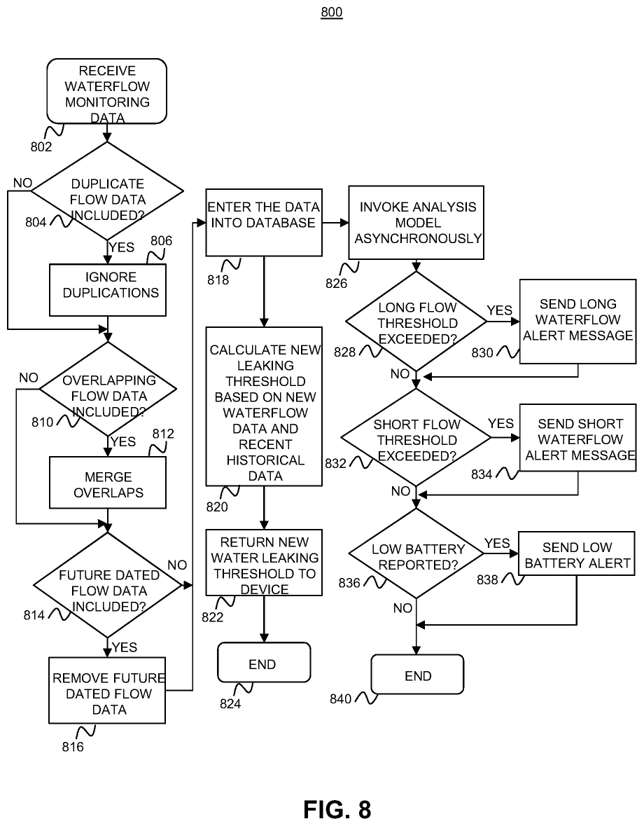

FIG. 8 illustrates a functional flow diagram of a process 800 corresponding to a service flowchart for a waterflow analysis system 104, according to one embodiment, in accordance with one embodiment. The process 800 can complete the various process steps using any of the methods, processes, and procedures discussed above with respect to FIGS. 1-7.

Referring to FIG. 8, and the description of FIGS. 1-4 above, at block 802, the waterflow analysis system 104 receives waterflow monitoring data from the waterflow monitoring device 102, according to one embodiment. From block 802 the process proceeds to block 804. At block 804, if the waterflow monitoring data includes duplicate flow data, then the process proceeds to block 806. If the waterflow monitoring data does not include duplicate flow data, then the process proceeds to block 810. At block 806, the duplications are ignored, according to one embodiment. From block 806 the process proceeds to block 810.

At block 810, if the waterflow monitoring data includes overlapping data, then the process proceeds to block 812. At block 812, the overlapping data is merged. From block 812, the process proceeds to block 814. At block 810, if the waterflow monitoring data does not include overlapping data, then the process proceeds to block 814.

At block 814, if the waterflow monitoring data includes future dated flow data, then the process proceeds to block 816. At block 816, the future dated flow data is removed. From block 816 the process proceeds to block 818. At block 814, if the waterflow monitoring data does not include future dated flow data, then the process proceeds to block 818.

At block 818, the waterflow monitoring data is entered into the waterflow monitoring database, according to one embodiment. From block 818 the process proceeds to block 820. At block 820, new leaking threshold data is calculated based on the new waterflow monitoring data and recent historical waterflow monitoring data, according to one embodiment. From block 820 the process proceeds to block 822. At block 822, the new water leaking threshold is output to the waterflow monitoring device 102. From block 822 the process proceeds to end at block 824, according to an embodiment. From block 818, the process also proceeds to block 826. At block 826, the analysis model is invoked asynchronously, according to one embodiment. From block 826 the process proceeds to block 828.

In one embodiment, if the long flow threshold is exceeded at block 828, then the process proceeds to block 830. At block 830, a long waterflow alert message is sent to the user computing device 106, according to one embodiment. From block 830, the process proceeds to block 832. At block 828, if the long flow threshold is not exceeded, then the process proceeds to block 832.

At block 832, if the short flow threshold is exceeded, then the process proceeds to block 834. At block 832, if the short flow threshold is not exceeded then the process proceeds to block 836. At block 834, a short flow waterflow alert message is output to the user computing device 106, according to one embodiment. From block 834, the process proceeds to block 836. At block 836, if a low battery is reported from the waterflow monitoring device 102, the process proceeds to block 838. At block 836 of a low battery is not reported, the process proceeds to block 840. At block 838, a low battery alert is sent to the user computing device 106, according to one embodiment. From block 838, the process proceeds to block 840. At block 840 the process ends, according to one embodiment.

Those of skill in the art will recognize, in light of the present disclosure, that the process 800 can include different steps and different orders of steps, other than those represented in FIG. 8 without departing from the scope of the present disclosure.

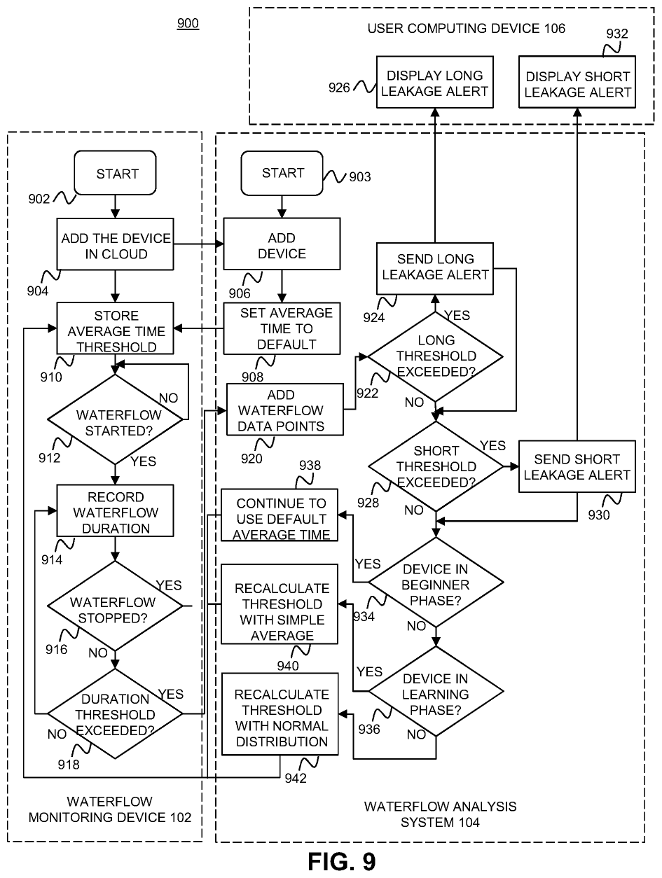

FIG. 9 illustrates a functional flow diagram of a process 900 for utilizing a waterflow monitoring device 102, a waterflow analysis system 104, and a user computing device 106 to assist a user in conserving water, in accordance with one embodiment. The process 900 can complete the various process steps using any of the methods, processes, and procedures discussed above with respect to FIGS. 1-7.

Referring to FIG. 9, and the description of FIGS. 1-4 above, the dashed boxes delineate which process functions are performed by the waterflow monitoring system 102, which process functions are performed by the waterflow analysis system 104, and which process functions are performed by the user computing device 106.

At block 902, the process starts in the waterflow monitoring system 102. From block 902, the process proceeds to block 904. At block 904 the waterflow monitoring system 102 requests to add the waterflow monitoring device 102 to the waterflow analysis system 104, according to one embodiment. From block 904, the process proceeds to block 906. Additionally, or alternatively, the process of the waterflow analysis system 104 can start at 903 with a request to add a new device. From block 903 the process proceeds to block 906. At block 906, the waterflow analysis system 104 registers the waterflow monitoring device 102 as ready for use, according to one embodiment. From block 906 the process proceeds to block 908. At block 908, the average waterflow time is set to a default value, according to one embodiment. From block 908, the process proceeds to block 910. At block 910, the waterflow monitoring device 102 stores the average flow time threshold, according to one embodiment. From block 910 the process proceeds to block 912.

At block 912, if waterflow has started, then the process proceeds to block 914. At block 914, the waterflow duration is recorded by the waterflow monitoring device 102. From block 914 the process proceeds to block 916. At block 916, if the waterflow has not stopped, then the process proceeds to block 918, according to one embodiment. At block 918, if the waterflow duration threshold has not been exceeded, then the process returns to block 914. At block 916, if the waterflow has stopped, then the process proceeds to block 920. At block 918, if the waterflow duration threshold has been exceeded, then the process proceeds to block 920.

At block 920, the waterflow analysis system 104 adds waterflow data points received in the waterflow notification data from the waterflow monitoring device 102, according to one embodiment. From block 920, the process proceeds to block 922. At block 922 if the long waterflow threshold has been exceeded, then the process proceeds to block 924. At block 924, the waterflow analysis system 104 outputs waterflow notification data including a long leakage alert to the user computing device 106, according to one embodiment. From block 924 the process proceeds to block 926. At block 926, the user computing device 106 displays the long leakage alert to the user, according to one embodiment. At block 922, if the long waterflow threshold has not been exceeded, and the process proceeds to block 928.

At block 928, if the short waterflow threshold has been exceeded, then the process proceeds to block 930. At block 930, the waterflow analysis system 104 sends waterflow notification data to the user computing device 106 including a short leakage alert, according to one embodiment. The user computing device 106 displays the short leakage alert to the user at block 932, according to one embodiment. At block 928, if the short waterflow threshold has not been exceeded, then the process proceeds to block 934.

At block 934, if the waterflow monitoring device 102 is in the beginner phase, then the process proceeds to block 938. At block 938, the waterflow analysis system 104 continues to use the default average time, according to one embodiment. From block 938, the process proceeds to block 910. If the waterflow monitoring device 102 is not in the beginner phase at block 934, the process proceeds to block 936. At block 936, if the waterflow monitoring device 102 in the learning phase, then the process proceeds to block 940. At block 940, the waterflow analysis system 104 recalculates the threshold with a simple average. From block 940, the process proceeds to block 910. At block 936, if the process is not in the learning phase, then the process proceeds to block 942. At block 942, the waterflow analysis system 104 recalculates the threshold with a normal distribution, according to one embodiment. From block 942, the process returns to block 910.

Those of skill in the art will recognize, in light of the present disclosure, that the process 900 can include different steps and different orders of steps, other than those represented in FIG. 9 without departing from the scope of the present disclosure.

Embodiments of the present disclosure address some of the shortcomings associated with traditional water conservation systems. Machine learning analysis is performed on waterflow metrics to determine water conservation data that can be provided to users based on the characteristics of the plumbing situations of the users. The various embodiments of the disclosure can be implemented to improve the technical fields of water conservation, data management, data processing, and data transmission. Therefore, the various described embodiments of the disclosure and their associated benefits amount to significantly more than an abstract idea.

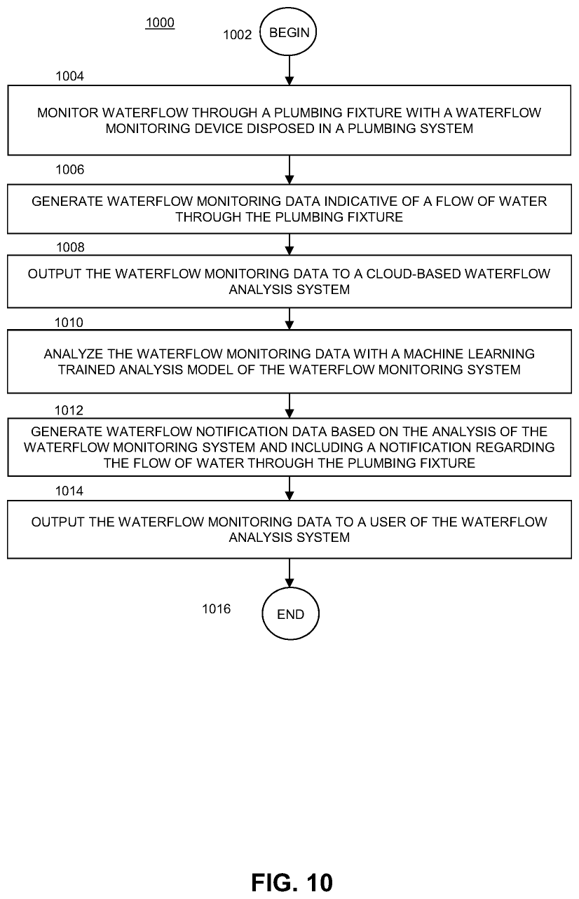

FIG. 10 illustrates a flow diagram of a process 1000 for assisting users to conserve water, according to various embodiments.

Referring to FIG. 10 and the description of FIGS. 1-9 above, in one embodiment, process 1000 begins at BEGIN 1002 and process flow proceeds to MONITOR WATERFLOW THROUGH A PLUMBING FIXTURE WITH A WATERFLOW MONITORING DEVICE DISPOSED IN A PLUMBING SYSTEM 1004.

In one embodiment, at MONITOR WATERFLOW THROUGH A PLUMBING FIXTURE WITH A WATERFLOW MONITORING DEVICE DISPOSED IN A PLUMBING SYSTEM 1004, waterflow is monitored through a plumbing fixture with a waterflow monitoring device disposed in a plumbing system, using any of the methods, processes, and procedures discussed above with respect to FIGS. 1-9.

In one embodiment, once waterflow is monitored through a plumbing fixture with a waterflow monitoring device disposed in a plumbing system

at MONITOR WATERFLOW THROUGH A PLUMBING FIXTURE WITH A WATERFLOW MONITORING DEVICE DISPOSED IN A PLUMBING SYSTEM 1004 process flow proceeds to GENERATE WATERFLOW MONITORING DATA INDICATIVE OF A FLOW OF WATER THROUGH THE PLUMBING FIXTURE 1006.

In one embodiment, at GENERATE WATERFLOW MONITORING DATA INDICATIVE OF A FLOW OF WATER THROUGH THE PLUMBING FIXTURE 1006, waterflow monitoring data is generated indicative of a flow of water through the plumbing fixture, using any of the methods, processes, and procedures discussed above with respect to FIGS. 1-9.

In one embodiment, once waterflow monitoring data is generated indicative of a flow of water through the plumbing fixture at GENERATE WATERFLOW MONITORING DATA INDICATIVE OF A FLOW OF WATER THROUGH THE PLUMBING FIXTURE 1006, process flow proceeds to OUTPUT THE WATERFLOW MONITORING DATA TO A CLOUD-BASED WATERFLOW ANALYSIS SYSTEM 1008.

In one embodiment, at OUTPUT THE WATERFLOW MONITORING DATA TOA CLOUD-BASED WATERFLOW ANALYSIS SYSTEM 1008, the waterflow monitoring data is output to a cloud-based waterflow analysis system, using any of the methods, processes, and procedures discussed above with respect to FIGS. 1-9.

In one embodiment, once the waterflow monitoring data is output to a cloud-based waterflow analysis system at OUTPUT THE WATERFLOW MONITORING DATA TO A CLOUD-BASED WATERFLOW ANALYSIS SYSTEM 1008, process flow proceeds to ANALYZE THE WATERFLOW MONITORING DATA WITH A MACHINE LEARNING TRAINED ANALYSIS MODEL OF THE WATERFLOW MONITORING SYSTEM 1010.

In one embodiment, at ANALYZE THE WATERFLOW MONITORING DATA WITH A MACHINE LEARNING TRAINED ANALYSIS MODEL OF THE WATERFLOW MONITORING SYSTEM 1010, the waterflow monitoring data is analyzed with a machine learning trained analysis model of the waterflow monitoring system, using any of the methods, processes, and procedures discussed above with respect to FIGS. 1-9.

In one embodiment, once the waterflow monitoring data is analyzed with a machine learning trained analysis model of the waterflow monitoring system at ANALYZE THE WATERFLOW MONITORING DATA WITH A MACHINE LEARNING TRAINED ANALYSIS MODEL OF THE WATERFLOW MONITORING SYSTEM 1010, process flow proceeds to GENERATE WATERFLOW NOTIFICATION DATA BASED ON THE ANALYSIS OF THE WATERFLOW MONITORING SYSTEM AND INCLUDING A NOTIFICATION REGARDING THE FLOW OF WATER THROUGH THE PLUMBING FIXTURE 1012.

In one embodiment, at GENERATE WATERFLOW NOTIFICATION DATA BASED ON THE ANALYSIS OF THE WATERFLOW MONITORING SYSTEM AND INCLUDING A NOTIFICATION REGARDING THE FLOW OF WATER THROUGH THE PLUMBING FIXTURE 1012, waterflow notification data is generated based on the analysis of the waterflow monitoring system and including a notification regarding the flow of water through the plumbing fixture, using any of the methods, processes, and procedures discussed above with respect to FIGS. 1-9.

In one embodiment, once waterflow notification data is generated based on the analysis of the waterflow monitoring system and including a notification regarding the flow of water through the plumbing fixture at GENERATE WATERFLOW NOTIFICATION DATA BASED ON THE ANALYSIS OF THE WATERFLOW MONITORING SYSTEM AND INCLUDING A NOTIFICATION REGARDING THE FLOW OF WATER THROUGH THE PLUMBING FIXTURE 1012, process flow proceeds OUTPUT THE WATERFLOW MONITORING DATA TO A USER OF THE WATERFLOW ANALYSIS SYSTEM 1014.

In one embodiment, at OUTPUT THE WATERFLOW MONITORING DATA TO A USER OF THE WATERFLOW ANALYSIS SYSTEM 1014, the waterflow monitoring data is output to a user of the waterflow analysis system, using any of the methods, processes, and procedures discussed above with respect to FIGS. 1-9.

In one embodiment, once the waterflow monitoring data is output to a user of the waterflow analysis system

at OUTPUT THE WATERFLOW MONITORING DATA TO A USER OF THE WATERFLOW ANALYSIS SYSTEM 1014, process flow proceeds to END 1016.

In one embodiment, at END 1016 the process for assisting users to conserve water is exited to await new data and/or instructions.

As noted above, the specific illustrative examples discussed above are but illustrative examples of implementations of embodiments of the method or process for assisting users to conserve water. Those of skill in the art will readily recognize that other implementations and embodiments are possible. Therefore, the discussion above should not be construed as a limitation on the claims provided below.

In one embodiment, a computing system implemented method assists users to conserve water. The method includes monitoring waterflow through a plumbing fixture with a waterflow monitoring device disposed in a plumbing system, generating waterflow monitoring data indicative of a flow of water through the plumbing fixture, and outputting the waterflow monitoring data to a cloud-based waterflow analysis system. The method includes analyzing the waterflow monitoring data with a machine learning trained analysis model of the waterflow monitoring system, generating waterflow notification data based on the analysis of the waterflow monitoring system and including a notification regarding the flow of water through the plumbing fixture, and outputting the waterflow monitoring data to a user of the waterflow analysis system.

In one embodiment, a system for assisting users to conserve water, the system includes at least one processor at least one memory coupled to the at least one processor. The at least one memory has stored therein instructions which, when executed by any set of the one or more processors, perform a process. The process includes monitoring waterflow through a plumbing fixture with a waterflow monitoring device disposed in a plumbing system, generating waterflow monitoring data indicative of a flow of water through the plumbing fixture, and outputting the waterflow monitoring data to a cloud-based waterflow analysis system. The process includes analyzing the waterflow monitoring data with a machine learning trained analysis model of the waterflow monitoring system, generating waterflow notification data based on the analysis of the waterflow monitoring system and including a notification regarding the flow of water through the plumbing fixture, and outputting the waterflow monitoring data to a user of the waterflow analysis system.

In one embodiment, a computing system implemented method assists users to conserve water. The method includes receiving, with a waterflow analysis system, waterflow monitoring data from a waterflow monitoring device indicating characteristics of waterflow in a plumbing fixture monitored by the waterflow monitoring device and analyzing the waterflow monitoring data with an analysis model of the waterflow monitoring system. The method includes generating waterflow notification data based on the analysis of the waterflow monitoring system and including a notification regarding the flow of water through the plumbing fixture and outputting the waterflow monitoring data to a user of the waterflow analysis system.

In one embodiment, a system assists users to conserve water. The system includes at least one processor at least one memory coupled to the at least one processor. The at least one memory has stored therein instructions which, when executed by any set of the one or more processors, perform a process. The process includes receiving, with a waterflow analysis system, waterflow monitoring data from a waterflow monitoring device indicating characteristics of waterflow in a plumbing fixture monitored by the waterflow monitoring device and analyzing the waterflow monitoring data with an analysis model of the waterflow monitoring system. The process includes generating waterflow notification data based on the analysis of the waterflow monitoring system and including a notification regarding the flow of water through the plumbing fixture and outputting the waterflow monitoring data to a user of the waterflow analysis system.

In one embodiment, A waterflow monitoring device includes a water input port configured to connect to a plumbing outlet of a plumbing system, a water output port configured to connect to a water input port of a plumbing fixture, and a water throughput configured to pass water from the plumbing outlet to the water input port of the plumbing fixture. The waterflow monitoring device includes a micro hydropower generator configured to detect waterflow through the water throughput, to generate electricity from the waterflow through the water throughput, and to generate waterflow signals indicative of waterflow through the water throughput. The waterflow monitoring device includes a wireless transceiver configured to pass data to a cloud-based waterflow analysis system via one or more networks and to receive data from the cloud-based waterflow analysis system via the one or more networks. The waterflow monitoring device includes a microcontroller coupled to the micro hydropower generator and the wireless transceiver and configured to generate waterflow monitoring data from the waterflow signals and to cause the wireless transceiver to output the waterflow monitoring data to the cloud-based waterflow analysis system.

The disclosed embodiments provide one or more technical solutions to the technical problem of ineffective water management systems. These and other embodiments of a water conservation system are discussed in further detail below.

Utilizing cloud-based machine learning trained analysis models to analyze water monitoring data is a technical solution to a long-standing technical problem and is not an abstract idea for at least a few reasons. First, utilizing cloud-based machine learning trained analysis models to analyze water monitoring data is a technical solution to a long-standing technical problem and is not an abstract idea for at least a few reasons is not an abstract idea because it is not merely an idea itself (e.g., can be performed mentally or using pen and paper). Second, utilizing cloud-based machine learning trained analysis models to analyze water monitoring data is a technical solution to a long-standing technical problem and is not an abstract idea because it is not a fundamental economic practice (e.g., is not merely creating a contractual relationship, hedging, mitigating a settlement risk, etc.). Third, utilizing cloud-based machine learning trained analysis models to analyze water monitoring data is a technical solution to a long-standing technical problem and is not an abstract idea for at least a few reasons is not an abstract idea because it is not a method of organizing human activity (e.g., managing a game of bingo). Fourth, although mathematics may be used to generate an analytics model, the disclosed and claimed methods and systems for assisting users to conserve water are not an abstract idea because the methods and systems are not simply a mathematical relationship/formula.

Utilizing cloud-based machine learning trained analysis models to analyze water monitoring data is a technical solution to a long-standing technical problem and is not an abstract idea because utilizing machine learning processes to better understand water monitoring data yields significant improvement to the technical fields of water conservation, water management, electronic data management, data processing, and data transmission, according to one embodiment.

As a result, embodiments of the present disclosure allow for reduced use of processor cycles, memory, and power consumption, by improving the effectiveness of water conservation systems. Consequently, computing and communication systems implementing or providing the embodiments of the present disclosure are transformed into more operationally efficient devices and systems. In addition to improving overall computing performance, utilizing cloud-based machine learning trained analysis models to analyze water monitoring data significantly improves the field of water conservation and water management systems by more efficiently providing personalized content to users, according to one embodiment. Therefore, both human and non-human resources are utilized more efficiently. Furthermore, by utilizing a time-location enrichment model to better understand transaction description strings, loyalty in the water conservation system is increased. This results in repeat customers, efficient water conservation services, and reduced abandonment of use of the water management system, according to one embodiment.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed system and method for providing access control and enhanced encryption determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the term storage container includes, but is not limited to, any physical or virtual data source or storage device. For instance, in various embodiments, a storage container can be, but is not limited to, one or more of a hard disk drive, a solid-state drive, an EEPROM, an optical disk, a server, a memory array, a database, a virtual database, a virtual memory, a virtual data directory, or other physical or virtual data sources.

As used herein, the term application container includes, but is not limited to, one or more profiles or other data sets that allow users and processes to access only particular data within a file system related to a storage container. For instance, in various embodiments, an application container can include, but is not limited to, a set of rules, a list of files, a list of processes, and/or encryption keys that provide access control to a file system such that a user associated with the application container can only access data, files, objects or other portions of a file system in accordance with the set of rules, the list of files, the list of processes, and/or encryptions keys.

As used herein, the term file includes, but is not limited to, a data entity that is a sequence of bytes that can be accessed individually or collectively.

As used herein the term data object includes, but is not limited to, a data entity that is stored and retrieved as a whole, or in large chunks, rather than as a sequence of bytes.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for assisting users to conserve water, the method comprising:
monitoring waterflow through a plumbing fixture with a waterflow monitoring device disposed in a plumbing system;
generating waterflow monitoring data indicative of a flow of water through the plumbing fixture;
outputting the waterflow monitoring data to a cloud-based waterflow analysis system;
analyzing the waterflow monitoring data with a machine learning trained analysis model of the waterflow monitoring system;
generating waterflow notification data based on the analysis of the waterflow monitoring system and including a notification regarding the flow of water through the plumbing fixture; and
outputting the waterflow monitoring data to a user of the waterflow analysis system.

2. The method of claim 1, wherein outputting the waterflow notification data includes outputting the waterflow monitoring data from the waterflow analysis model to a computing device of the user.

3. The method of claim 2, wherein outputting the waterflow notification data includes displaying the waterflow notification data to the user on the computing device of the user.

4. The method of claim 1, wherein the notification data indicates that the plumbing fixture is leaking.

5. The method of claim 1, wherein the notification data includes one or more of:
aggregated waterflow through the plumbing fixture for a selected period;
a comparison of aggregated waterflow through the plumbing fixture for two or more selected periods;
a duration of waterflow;
an average waterflow;
time ranges of waterflow; and
dates on which waterflow occurred.

6. The method of claim 1, wherein the plumbing fixture is a toilet.

7. The method of claim 6, further comprising calculating an average water tank refill time of the toilet.

8. The method of claim 7, wherein analyzing the waterflow monitoring data includes determining whether the toilet is leaking by comparing the waterflow monitoring data to the average water tank refill time.

9. The method of claim 8, wherein the waterflow notification data informs the user that the toilet is leaking.

10. The method of claim 8, further comprising:
generating a short leak threshold and a long leak threshold based on the average flush refill time;
determining whether there is a short leak or a long leak by comparing the waterflow notification data to the short leak threshold and the long leak threshold; and
indicating in the notification data whether there is a leak based on the comparison to the short leak threshold and the long leak threshold.

11. A computing system implemented method for assisting users to conserve water, the method comprising:
receiving, with a waterflow analysis system, waterflow monitoring data from a waterflow monitoring device indicating characteristics of waterflow in a plumbing fixture monitored by the waterflow monitoring device;
analyzing the waterflow monitoring data with an analysis model of the waterflow monitoring system;
generating waterflow notification data based on the analysis of the waterflow monitoring system and including a notification regarding the flow of water through the plumbing fixture; and
outputting the waterflow monitoring data to a user of the waterflow analysis system.

12. The method of claim 11, further comprising configuring the waterflow monitoring device with the waterflow analysis system prior to receiving waterflow monitoring data from the waterflow monitoring device.

13. The method of claim 12, wherein configuring the waterflow monitoring device includes sending control data to the waterflow monitoring device from the waterflow analysis system via the Internet.

14. The method of claim 11, wherein the waterflow analysis system is a cloud-based waterflow analysis system.

15. The method of claim 11, further comprising training the analysis model with a machine learning process.

16. The method of claim 11, wherein outputting the waterflow notification data includes outputting the notification data to a waterflow analysis application installed on a computing device of the user.

17. The method of claim 11, wherein the waterflow notification data indicates how waterflow through the plumbing fixture compares to waterflow associated with plumbing fixtures of other users of the waterflow analysis system.

18. A waterflow monitoring device comprising:
a water input port configured to connect to a plumbing outlet of a plumbing system;
a water output port configured to connect to a water input port of a plumbing fixture;
a water throughput configured to pass water from the plumbing outlet to the water input port of the plumbing fixture;
a micro hydropower generator configured to detect waterflow through the water throughput, to generate electricity from the waterflow through the water throughput, and to generate waterflow signals indicative of waterflow through the water throughput;
a wireless transceiver configured to pass data to a cloud-based waterflow analysis system via one or more networks and to receive data from the cloud-based waterflow analysis system via the one or more networks;
a microcontroller coupled to the micro hydropower generator and the wireless transceiver and configured to generate waterflow monitoring data from the waterflow signals and to cause the wireless transceiver to output the waterflow monitoring data to the cloud-based waterflow analysis system.

19. The waterflow monitoring device of claiml8, further comprising a battery configured to power the microcontroller and the wireless transceiver.

20. The waterflow monitoring device of claim 19, wherein the microcontroller is configured to selectively receive power from the micro hydropower generator when the micro hydropower generator generates sufficiently stable electricity to power the microcontroller and the wireless transceiver.

21. The waterflow monitoring device of claim 20 wherein the microcontroller is configured to cause the micro hydropower generator to recharge the battery when the micro hydropower generator generates sufficient electricity to power the microcontroller and the wireless transceiver with excess to charge the battery.

22. The waterflow monitoring device of claim 18, further comprising a valve configured to selectively close the water throughput so that no water can flow through the water throughput.

23. The waterflow monitoring device of claim 22, wherein the valve can be actuated electronically in response to a command received from the waterflow analysis system.

24. The waterflow monitoring device of claim 22, wherein the valve can be actuated electronically in response to a command received from a user computing device operated by a user of the waterflow analysis system.
